(19) United States
(12) Patent Application Publication
(10) Pub. No.: US 2009/0283942 A1
(43) Pub. Date: Nov. 19, 2009

(54) VIBRATION TRANSMISSION DAMPING APPARATUS

(75) Inventor: Sachio Nakamura, Hiratsuka (JP)

Correspondence Address: GREER, BURNS & CRAIN, 300 S WACKER DR, 25TH FLOOR, CHICAGO, IL, 60606, US

(73) Assignee: THE YOKOHAMA RUBBER CO., LTD., Tokyo (JP)

(21) Appl. No.: 12/442,646

(22) PCT Filed: May 7, 2007
(86) PCT No.: PCT/JP2007/059814

§ 371 Date: Mar. 24, 2009

(30) Foreign Application Priority Data
Sep. 26, 2006 (JP) 2006-260736
Sep. 29, 2006 (JP) 2006-269421

(51) Int. Cl. F16F 15/02; B60G 17/015

(52) U.S. Cl. 267/64.13; 267/118

(57) ABSTRACT

A vibration transmission damping apparatus (1) is attached to a structural object (13) and supports the structural object (13). The vibration transmission damping apparatus (1) includes a cylinder (2) and a piston (3) arranged inside the cylinder (2). A space enclosed by the piston (3) and the cylinder (2) forms a fluid chamber (4) which is filled with air. The piston (3) supports the structural object (13) by pressure generated by the air. A fluid passage (7) which communicates the fluid chamber (4) with the outside is connected to the fluid chamber (4). Further, the fluid passage (7) is provided with an on-off valve (8V). The on-off valve (8V) is opened/closed at frequency of vibration whose transmission to the structural object (13) is not desirable so as to discharge the air in the fluid chamber (4) to the outside.

### TECHNICAL FIELD

The present invention relates to a vibration transmission damping apparatus which damps vibration of a specific frequency transmitted to a structural object.

### BACKGROUND ART

Conventionally, a vibration absorber such as rubber is employed to support a structural object, such as a machine tool, high-precision printing machine, and architectural structure, when vibration transmission or shock transfer to or from the structural object is not desirable. For example, Patent Documents 1 and 2 describe a rubber bearing configured with laminated rubber and used in seismic isolator devices. Further, Patent Document 3 describes a vibration isolator with an air spring and used for supporting precision apparatuses. Still further, Patent Document 4 describes an air spring in which: an inner space of a cylinder is divided into two chambers by a piston; a passageway is formed in the piston to communicate two chambers with each other; a valve composed of two metal foils is arranged in the passageway; and an input of the same frequency as the self-sustained frequency of the valve is prevented from being transmitted to a portion supported by the spring.

Patent Document 1: Japanese Patent Application Laid-Open No. 2006-200158

Patent Document 2: Japanese Patent Application Laid-Open No. 2006-200159

Patent Document 3: Japanese Patent Application Laid-Open No. 2004-347125

Patent Document 4: U.S. Pat. No. 4,635,909

### DISCLOSURE OF INVENTION

### Problem to be Solved by the Invention

Damping using rubber or the air spring as described above has difficulties in selectively blocking the vibration of a specific frequency and therefore has a possibility of transmitting unwanted vibration to the structural object. Hence, there is a room of improvement in terms of vibration transmission damping. In view of the foregoing, an object of the present invention is to provide a vibration transmission damping apparatus which can damps the transmission of vibration of a specific frequency to a supported structural object or the transmission of vibration of a specific frequency generated by the structural object.

### Means for Solving Problem

In order to achieve the object, a vibration transmission damping apparatus according to one aspect of the present invention is attached to a structural object to support the structural object, and includes a fluid chamber filled with a fluid and arranged between a vibrational source and the structural object, and a fluid-path opening/closing unit arranged in a fluid path communicating an inside of the fluid chamber with an outside of the fluid chamber to open/close the fluid path at a predetermined frequency corresponding to a specific frequency.

The vibration transmission damping apparatus includes the fluid chamber filled with the fluid and arranged between the vibration source and the structural object to which the vibration transmission is not desirable, and the fluid-path opening/closing unit arranged in the fluid path communicating the inside of the fluid chamber with the outside of the fluid chamber to open/close the fluid path at the predetermined frequency corresponding to the specific frequency. When the vibration is input to the fluid chamber, the fluid-path opening/closing unit operates to open/close the fluid path at the predetermined frequency. Thus, the fluid in the fluid chamber is discharged successively at the predetermined frequency outside the fluid chamber.

Having the above-described structure, the vibration transmission damping apparatus works as a frequency filter having a gain of zero at the predetermined frequency and a gain of approximately 1.0 at frequencies other than the predetermined frequency. Therefore, the vibration of the predetermined frequency is blocked by the vibration transmission damping apparatus and would not be transmitted to the structural object supported by the vibration transmission damping apparatus substantially. Thus, the transmission of vibration of the predetermined frequency to the supported structural object or the transmission of vibration generated by the structural object can be damped.

The vibration transmission damping apparatus according to another aspect of the present invention may further include a fluid chamber filled with a fluid, and a vibration input unit reciprocating relative to the fluid chamber to input vibration from the vibration source to the fluid chamber, and the fluid-path opening/closing unit may open/close the fluid path at a specific frequency corresponding to a frequency of reciprocation of the vibration input unit relative to the fluid chamber.

In the vibration transmission damping apparatus according to still another aspect of the present invention, the fluid chamber may include a first fluid chamber and a second fluid chamber, the vibration input unit may be arranged between the first fluid chamber and the second fluid chamber, and the fluid path may be a passage connecting the first fluid chamber and the second fluid chamber.

In the vibration transmission damping apparatus according to still another aspect of the present invention, a frequency detector may be attached to the structural object to identify vibration frequency of the structural object, and the fluid-path opening/closing unit may open/close the fluid path at a predetermined frequency determined based on the vibration of the structural object detected by the frequency detector.

In the vibration transmission damping apparatus according to still another aspect of the present invention, the fluid is gaseous matter preferably.

In the vibration transmission damping apparatus according to still another aspect of the present invention, the fluid is liquid such as water and oil, preferably.

In the vibration transmission damping apparatus according to still another aspect of the present invention, the structural object may be a vehicle body of a vehicle. The vibration transmission damping apparatus may include a fluid chamber filled with the fluid and arranged between the vehicle body and a wheel of the vehicle to support the vehicle body; and a vibration input unit reciprocating relative to the fluid chamber to input vibration from either one of the vehicle body or the wheel to the fluid chamber. Further, the fluid-path opening/closing unit opens/closes the fluid path at a predetermined frequency corresponding to a frequency of reciprocation of the vibration input unit relative to the fluid chamber.

While a suspension system (suspension apparatus) for vehicles running on a road or railroad vehicles is used, supported mass may be changed. For example, while the suspension system for vehicle is used, the supported mass changes according to the changes in the number of passengers or the sustained load. As a result, the natural frequency of the vibration system changes. The change in the natural frequency of the vibration system causes degradation in damping performance of resonance amplification.

The vibration transmission damping apparatus according to the present invention utilizes gaseous matter such as air and nitrogen as a fluid. Further, the vibration transmission damping apparatus includes the fluid chamber filled with the gaseous matter mentioned above, and the vibration input unit which reciprocates relative to the fluid chamber to input the vibration to the fluid chamber. The fluid path connected to the fluid chamber is opened/closed at the predetermined frequency corresponding to a frequency of reciprocation of the vibration input unit relative to the fluid chamber. Having such a structure, the vibration transmission damping apparatus works as a frequency filter having a gain of zero for the predetermined frequency and having a gain of approximately 1.0 for frequencies other than the predetermined frequency. Therefore, the vibration of the predetermined frequency is blocked by the vibration transmission damping apparatus and would not be transmitted to the vehicle body supported by the vibration transmission damping apparatus substantially. Thus, even when the natural frequency of the vibration system configured with the vibration transmission damping apparatus and the vehicle body supported thereby changes, the vibration transmission damping apparatus of the present invention can exert the damping effect for the vibration of the supported vehicle body by changing the frequency at which the fluid path connected to the fluid chamber is opened/closed according to the change in the natural frequency so as to support the static load.

The vibration transmission damping apparatus according to still another aspect of the present invention may include a fluid amount detector detecting an amount of the fluid filling the fluid chamber, and a fluid supply unit supplying the fluid to the fluid chamber when the amount of the fluid filling the fluid chamber detected by the fluid amount detector is a predetermined threshold or less.

In the vibration transmission damping apparatus according to still another aspect of the present invention, the fluid chamber may include a first fluid chamber and a second fluid chamber, the vibration input unit may be arranged between the first fluid chamber and the second fluid chamber, and the fluid path may connect the first fluid chamber and the second fluid chamber.

In the vibration transmission damping apparatus according to still another aspect of the present invention, the second fluid chamber may be arranged opposite to the first fluid chamber, the vibration input unit may be supported by the first fluid chamber and the second fluid chamber, and a load supporting area of the vibration input unit in contact with the first fluid chamber may be larger than a load supporting area of the vibration input unit in contact with the second fluid chamber.

In the vibration transmission damping apparatus according to still another aspect of the present invention, the vibration detector may be attached either to the vehicle body or at least one of sprung masses of a vehicle, and said vibration detector may be employed to identify a frequency with maximum vibration power, the fluid-path opening/closing unit may open/close at the found frequency, at an integral multiple of the found frequency, or at a frequency equal to the found frequency divided by an integer.

In the vibration transmission damping apparatus according to still another aspect of the present invention, a power of the frequency of the maximum vibration power may be identified, and a ratio of an opening time to a closing time at the opening/closing of the fluid-path opening/closing unit may be changed according to the level of the vibration power.

In the vibration transmission damping apparatus according to still another aspect of the present invention, the vibration detector may be employed to find plural frequencies in descending order of vibration power, and the fluid-path opening/closing unit may opens/closes at the found frequencies, or integral multiples of the found frequencies, or frequencies equal to the found frequencies divided by an integer.

In the vibration transmission damping apparatus according to still another aspect of the present invention, a ratio of an opening time to a closing time at the opening/closing of the fluid-path opening/closing unit may be changed for each of the found frequencies according to the vibrational power of each of the found frequencies.

The vibration transmission damping apparatus according to still another aspect of the present invention may further include an elastic body that supports the vibration input unit.

### EFFECT OF THE INVENTION

According to the present invention, the vibration transmission damping apparatus can damp the vibration transmission of a specific frequency to a supported structural object or the vibration transmission of a specific frequency generated by the structural object. Further, the vibration transmission damping apparatus according to the present invention can keep supporting the load of a vehicle body, which is the structural object, while exerting a damping effect of vibration transmission to the vehicle body even when the natural frequency of a vibration system composed of the vibration transmission damping apparatus and the mass of the supported vehicle body changes.

### BRIEF DESCRIPTION OF DRAWINGS

FIG. 1 is a conceptual diagram of a vibration transmission damping apparatus according to a first embodiment of the present invention;

FIG. 2 is a schematic diagram of a vibration transmission damping apparatus according to a first modification of the first embodiment;

FIG. 3 is a schematic diagram of a vibration transmission damping apparatus according to a second modification of the first embodiment;

FIG. 4 is a schematic diagram of a vibration transmission damping apparatus according to a third modification of the first embodiment;

FIG. 5 is a schematic diagram of a vibration transmission damping apparatus according to a fourth modification of the first embodiment;

FIG. 6 is a graph illustrating an exemplary procedure of vibration transmission damping according to the first embodiment;

FIG. 7 is a graph illustrating an exemplary procedure of vibration transmission damping according to the first embodiment;

FIG. 8 is a graph illustrating an exemplary procedure of vibration transmission damping according to the first embodiment;

FIG. 9 is a graph illustrating an exemplary procedure of vibration transmission damping according to the first embodiment;

FIG. 10 is a graph illustrating another exemplary control procedure of vibration transmission damping according to the first embodiment;

FIG. 11A is a graph illustrating another exemplary control procedure of vibration transmission damping according to the first embodiment;

FIG. 11B is a graph illustrating another exemplary control procedure of vibration transmission damping according to the first embodiment;

FIG. 12 is a graph illustrating another exemplary control procedure of vibration transmission damping according to the first embodiment;

FIG. 13 is a graph illustrating another exemplary control procedure of vibration transmission damping according to the first embodiment;

FIG. 14 is a schematic diagram of an application of the vibration transmission damping apparatus according to the first embodiment;

FIG. 15A is a schematic diagram of a structure of a vehicle-body supporting apparatus according to a second embodiment;

FIG. 15B is a schematic diagram of another example of a fluid-path opening/closing unit;

FIG. 16A is a schematic diagram of another example of the structure of the vehicle-body supporting apparatus according to the second embodiment;

FIG. 16B is a schematic diagram of still another example of the structure of the vehicle-body supporting apparatus according to the second embodiment;

FIG. 16C is a schematic diagram of still another example of the structure of the vehicle-body supporting apparatus according to the second embodiment;

FIG. 16D is a schematic diagram of still another example of the structure of the vehicle-body supporting apparatus according to the second embodiment;

FIG. 16E is a schematic diagram of a structure of a vehicle-body supporting apparatus, which is applicable to a suspension system, according to the second embodiment;

FIG. 16F is a schematic diagram of a structure of a vehicle-body supporting apparatus, which is applicable to the suspension system, according to the second embodiment;

FIG. 17 is a conceptual diagram of the vehicle-body supporting apparatus of the second embodiment arranged to a vehicle;

FIG. 18 is a schematic diagram of a structure of a vibration controller according to the second embodiment; and

FIG. 19 is a functional block diagram of components performing Fourier analysis according to the second embodiment.

### EXPLANATIONS OF LETTERS OR NUMERALS

1, 1a, 1b, 1c, 1d, 1c_h, 1c_v Vibration transmission damping apparatus
1S, 1sa, 1sb, 1sc, 1sd, 1se Vehicle-body supporting apparatus
2 Cylinder
2C Communicating hole
2H Fluid-passing hole
3 Piston
3A, 3B Load-transfer member
4 Fluid chamber
4A First fluid chamber
4B Second fluid chamber
5 Piston rod
6 Air spring
7 Fluid passage
8 Fluid-path opening/closing unit
8A Actuator
8V On-off valve
10 Shock-absorbing member
11 Structural-object supporting member
12 Connecting member
13 Structural object
14 Connecting tube
Buffer tank
16 Fluid supply tube
17 Fluid tank
18 Fluid supply valve
20 Suspension system
21L Lower arm
21U Upper arm
24 Wheel
30 Vehicle-body acceleration sensor
31 Suspension-system acceleration sensor
32 Stroke sensor
40 Vibration controller
40M Storage unit
40P CPU
41 Frequency setting unit
42 Communicating-time setting unit
43 Valve controller
44 Input port
45 Output port
50 Fluid supply controller
51 Vibration transmission damping controller
52 Position sensor
53 Vibration detection sensor
54 Apparatus
55 Base
56 Trench
60 Pump
100 Vehicle
100B Vehicle body

### BEST MODE(S) FOR CARRYING OUT THE INVENTION

Exemplary embodiments of the present invention will be described in detail below with reference to the accompanying drawings. It should be noted that the present invention is not limited to the embodiments. Components of the embodiments may include those which can be readily achieved by those skilled in the art, or those equivalent to, i.e., those rest within the equivalent scope of the components readily achieved by those skilled in the art. An advantageous effect of the present invention can be realized similarly when a “fluid” mentioned below is gaseous matter or fluid matter. However, the use of the gaseous matter is preferable since the gaseous matter can be dissipated into the air.

### First Embodiment

A vibration transmission damping apparatus according to a first embodiment is characterized by a fluid chamber filled with a fluid and arranged between a vibration source and a structural object which is to be blocked from the transmission of the vibration, and a fluid path opening/closing unit arranged in a fluid path, which communicates an interior of the fluid chamber and an exterior of the fluid chamber, so as to open/close the fluid path at a specific frequency. More specifically, according to the first embodiment, the fluid path, which is connected to the fluid chamber filled with the fluid such as air, nitrogen, water, and oil, for supporting the load, is opened/closed periodically so that the fluid in the fluid chamber is partially released to the outside (into the air) or to another fluid chamber. As a result, the spring stiffness of the fluid chamber decreases against an external force having the same period as the frequency of the opening/closing operations of the fluid path. The first embodiment utilizes the cyclical decrease of the spring stiffness so that the vibration transmission to the supported structural object or from the supported structural object can effectively be damped regardless of the change in the natural frequency. When the fluid is described as being “released”, it means that the gaseous matter in the fluid chamber is discharged outside the fluid chamber if there is only one fluid chamber, and that the gaseous matter in a high-pressure side fluid chamber moves to a low-pressure side fluid chamber if there are two fluid chambers separated by a vibration input unit (such as a piston).

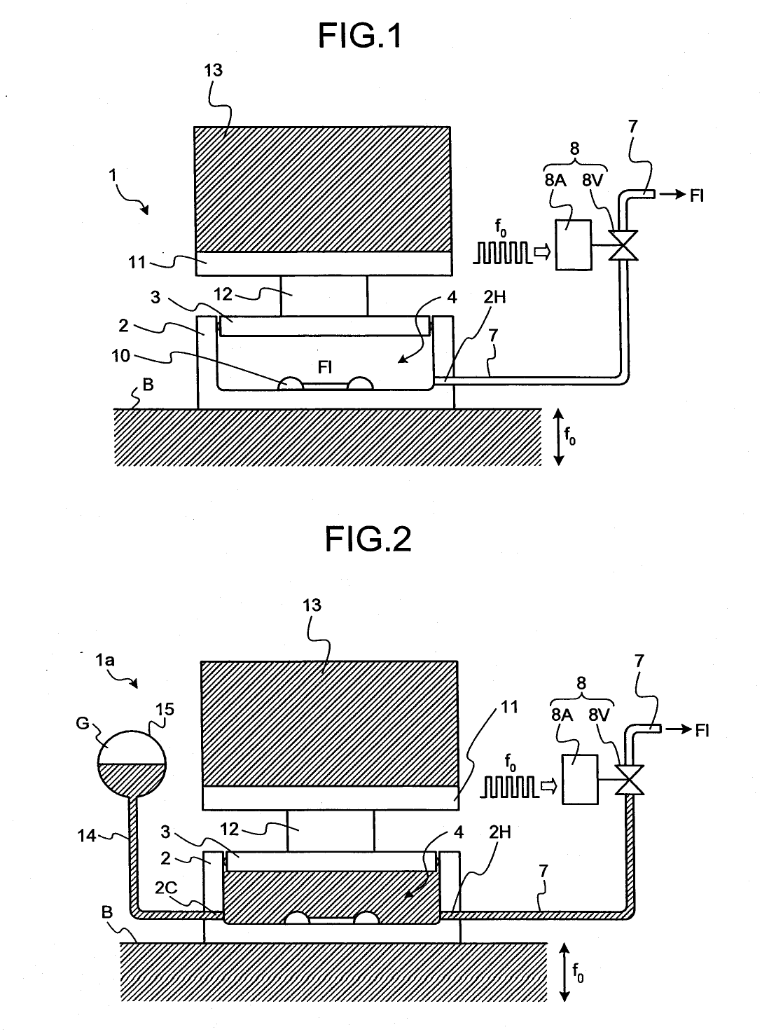

FIG. 1 is a conceptual diagram of the vibration transmission damping apparatus according to the first embodiment. A vibration transmission damping apparatus 1 according to the first embodiment includes a cylinder 2, a piston 3 which is attached to the cylinder 2 so that the piston 3 can reciprocate inside the cylinder 2, a fluid path (formed with a fluid-passing hole 2H and a fluid passage 7) which communicates a space enclosed by the piston 3 and the cylinder 2 with the outside, and a fluid-path opening/closing unit 8 which opens/closes the fluid path at a specific frequency. The space enclosed by the piston 3 and the cylinder 2 forms a fluid chamber 4 and is filled with a fluid F1 (such as gaseous matter which is a compressible fluid, a liquid matter which is an uncompressible fluid, and mixture of the gaseous matter and the liquid matter). In the first embodiment, the fluid chamber 4 is filled with air, which serves as the fluid F1. The air is pressurized to a predetermined pressure level. Further, a sealing member is arranged between the cylinder 2 and the piston 3 to maintain the air-tightness of the fluid chamber 4. The fluid chamber 4 may be configured with an elastic body such as rubber.

In the first embodiment, the cylinder 2 is placed on a base B, e.g., a floor of the vibration transmission suspension apparatus 1. The cylinder 2 serves as a vibration input unit which inputs the vibration generated by the vibration source to the fluid chamber 4 by reciprocating relative to the fluid chamber 4. Here, the vibration input unit that inputs the vibration from the vibration source to the fluid chamber 4 can be the piston 3 instead of the cylinder 2. A component which serves as the vibration input unit is determined relatively in the vibration transmission damping apparatus 1 of the first embodiment.

Further, a structural-object supporting member 11 is attached to the piston 3 via a connecting member 12 so as to support a structural object 13. Accordingly, the structural object 13 is supported by the fluid F1 which fills the fluid chamber 4. In the first embodiment, the fluid F1 filling the fluid chamber 4 is the air. Therefore, the vibration transmission damping apparatus 1 of the first embodiment works like an air spring.

Still further, a shock-absorbing member 10 is arranged inside the cylinder 2 (i.e., inside the fluid chamber 4) at a position opposite to the piston 3. The shock-absorbing member 10 relieves a shock generated when the piston 3 hits the cylinder 2 after the fluid F1 is completely drained out from the fluid chamber 4. The shock-absorbing member 10 is configured with an elastic body such as rubber and elastomer, for example.

The cylinder 2 has the fluid-passing hole 2H through which the fluid F1 in the fluid chamber 4 is discharged outside the fluid chamber 4. The fluid-passing hole 2H leads to the fluid passage 7. The fluid F1 in the fluid chamber 4 runs through the fluid path configured with the fluid-passing hole 2H and the fluid passage 7, and is discharged outside the fluid chamber 4. The fluid passage 7 is provided with the fluid-path opening/closing unit 8 which opens/closes the fluid passage 7, i.e., the fluid path at a specific frequency when a predetermined condition is met. Thus, the fluid F1 inside the fluid chamber 4 is discharged outside the fluid chamber 4 at a specific frequency. The fluid-path opening/closing unit 8 may be directly attached to the fluid-passing hole 2H.

The fluid-path opening/closing unit 8 includes an on-off valve 8V, and an actuator (such as a solenoid, piezoelectric element, and ultrasonic motor) 8A that opens/closes the on-off valve 8V. When the actuator 8A closes the on-off valve 8V, the fluid passage 7 is shut off and the fluid F1 is confined to the fluid chamber 4. On the other hand, when the actuator 8A opens the on-off valve 8V, the fluid passage 7, i.e., the fluid path is communicated with the fluid chamber 4, and the fluid inside the fluid chamber 4 is discharged through the fluid path to the outside of the fluid chamber 4.

For the damping of vibration transmitted from the base B to the structural object 13 supported by the vibration transmission damping apparatus 1, the on-off valve 8V is made to open/close at a frequency f₀ of the vibration whose transmission is to be damped (or at an integral multiple of f₀, or at a frequency obtained by dividing the frequency f₀ by an integer). As a result, the spring stiffness of the vibration transmission damping apparatus 1 becomes smaller for the vibration whose transmission is to be damped than for the vibrations of other frequencies. Thus, the vibration transmission damping apparatus 1 of the first embodiment has a smaller transmissibility for the vibration of the frequency f₀ whose transmission is to be damped than for vibrations of other frequencies, and is able to damp the transmission of an intended vibration, which is input from the base B, to the structural object 13. At the same time, while bearing the load of the structural object 13, the vibration transmission damping apparatus 1 retains a larger transmissibility for the vibrations of frequencies other than the frequency f₀ in comparison with the transmissibility for the vibration of the frequency f₀. Such a characteristic is particularly important for supporting a static load (for which the vibrational frequency corresponds to zero).

In the above description, the vibration transmission from the base B to the structural object 13 is damped. Similarly, however, the vibration transmission from the structural object 13 to the base B can be damped. For example, when the structural object 13 includes an electric motor which causes vibrations of a specific frequency successively due to eccentricity thereof, the on-off valve 8V of the vibration transmission damping apparatus 1 may be made to open/close at the frequency of the vibrations caused by the eccentricity of the electric motor. Then, the vibration transmission damping apparatus 1 can damp the transmission of the vibrations from the structural object 13 to the base B.

First Modification

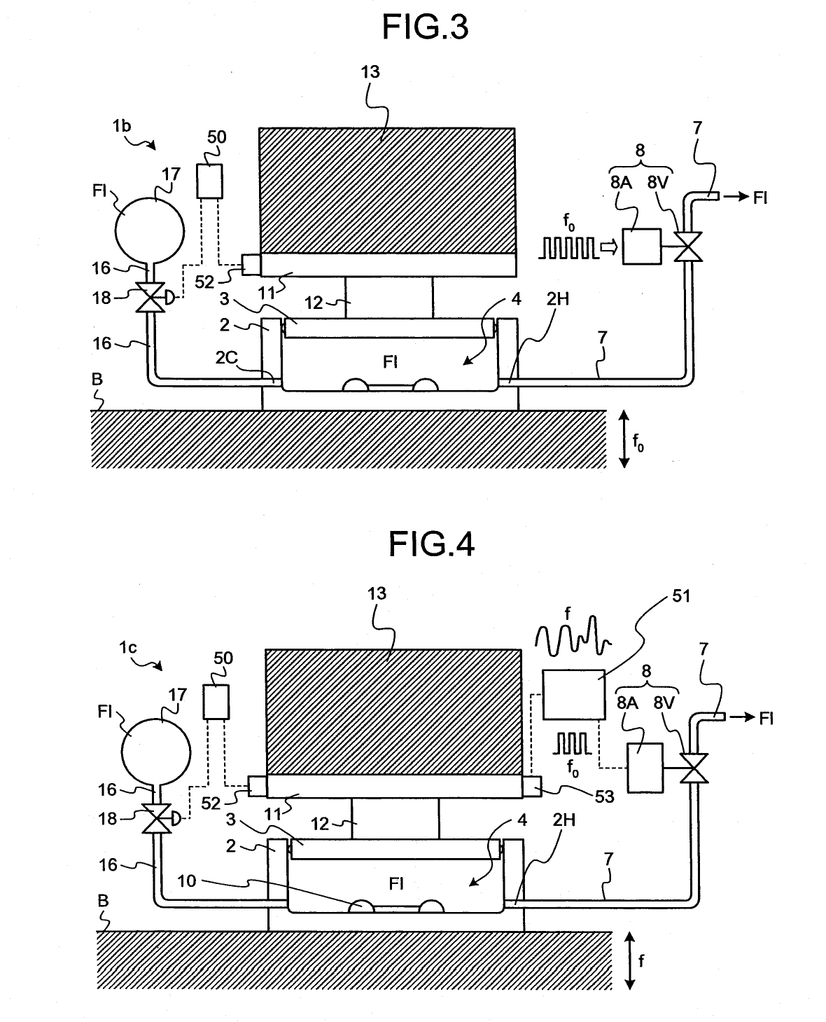

FIG. 2 is a schematic diagram of a vibration transmission damping apparatus of a first modification of the first embodiment. A vibration transmission damping apparatus 1a of the first modification has substantially the same structure as that of the vibration transmission damping apparatus 1 (FIG. 1) of the first embodiment. The first modification is different from the first embodiment in that the fluid F1 filling the fluid chamber 4 is an incompressible fluid (such as oil). The vibration transmission damping apparatus 1a can support the structural object 13 more securely than the vibration transmission damping apparatus 1 since the incompressible fluid (hereinafter simply referred to as “fluid”) F1 fills the fluid chamber 4.

When the on-off valve 8V is opened/closed for the damping of the vibration transmission to the structural object 13 or the vibration transmission from the structural object 13, however, sudden shut-off of the on-off valve 8V might cause a sudden rise of pressure of the fluid F1 filling the fluid path (fluid-passing hole 2H and fluid passage 7) and the fluid chamber 4, and may break the apparatus or deliver shockwaves to the structural object 13 via the piston 3. To prevent such undesirable outcomes, a communicating hole 2C formed in the fluid chamber 4 is connected to a buffer tank 15 via a connecting tube 14, and gaseous matter G in the buffer tank absorbs the pressure changes of the fluid F1 at the time of opening/closing of the on-off valve 8V. Thus, while damping the vibration transmission to the structural object 13 or from the structural object 13, the vibration transmission damping apparatus 1a can damp the generation of shockwaves attributable to the raised pressure of the fluid F1.

Second Modification

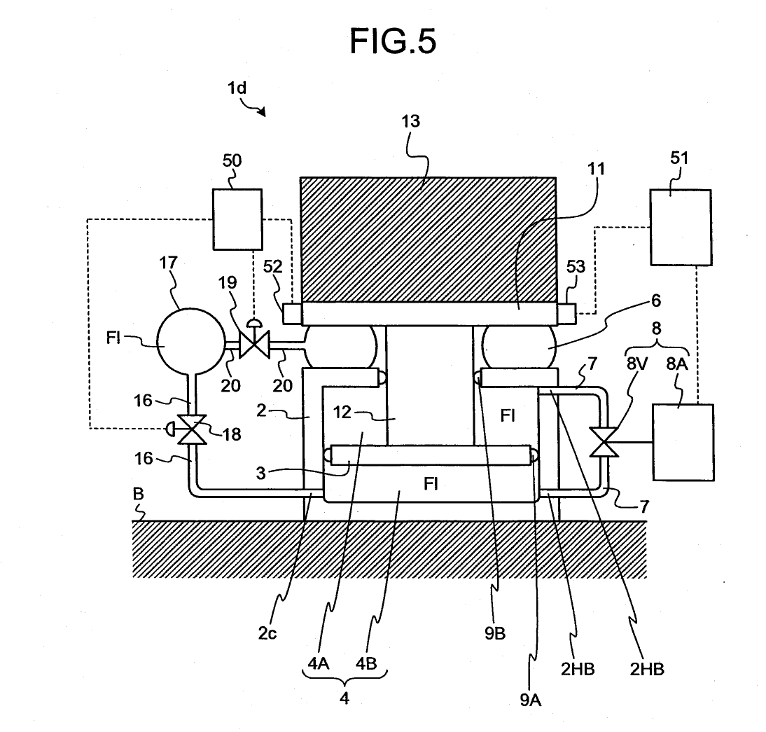

FIG. 3 is a schematic diagram of a vibration transmission damping apparatus of a second modification of the first embodiment. A vibration transmission damping apparatus 1b of the second modification has substantially the same structure as the vibration transmission damping apparatus 1 of the first embodiment (FIG. 1). The vibration transmission damping apparatus 1b is different from the vibration transmission damping apparatus 1 in that a fluid replenishing unit that replenishes the fluid F1 discharged from the fluid chamber 4 is provided. Since the vibration transmission damping apparatus 1b can replenish the fluid F1 discharged from the fluid chamber 4 to the outside at the time of opening/closing of the on-off valve 8V, to maintain the amount of the fluid F1 filling the fluid chamber 4 to a certain level, the vibration transmission damping apparatus 1b can exert a stable vibration transmission damping function. Further, since the vibration transmission damping apparatus 1b of the second modification replenishes the fluid F1 discharged from the fluid chamber 4 to the outside, the vibration transmission damping apparatus 1b can work longer hours in comparison with the vibration transmission damping apparatus 1 (FIG. 1).

The fluid replenishing unit of the vibration transmission damping apparatus 1b of the second modification includes a fluid tank 17, a fluid supply tube 16, a fluid supply valve 18, and a fluid supply controller 50. As shown in FIG. 3, the communicating hole 2C arranged in the fluid chamber 4 is connected to the fluid tank 17 through the fluid supply tube 16. Further, the fluid supply valve 18 is attached to the fluid supply tube 16 (i.e., a portion between the fluid tank 17 and the fluid chamber 4). The opening/closing of the fluid supply valve 18 is controlled by the fluid supply controller 50 which includes a CPU (Central Processing Unit), memory, and the like. The fluid supply valve 18 is usually closed.

The fluid supply controller 50 receives information on the position of the structural-object supporting member 11 from a position sensor 52 which detects the position of the structural-object supporting member 11 of the vibration transmission damping apparatus 1b. When the amount of the fluid F1 in the fluid chamber 4 decreases and the structural-object supporting member 11 comes below a predetermined level, the fluid supply controller 50 opens the fluid supply valve 18 to replenish the fluid chamber 4 with the fluid in the fluid tank 17.

In the second modification, the fluid F1 is discharged from the fluid chamber 4 to the outside according to the opening/closing operations of the on-off valve 8V. The discharged fluid F1 may be returned to the fluid tank 17 rather than simply disposed outside. Then, the decrease of the amount of the fluid F1 filling the fluid tank 17 can be suppressed substantially, whereby the replenishing unit for replenishing the fluid tank 17 with the fluid F1 can be eliminated and the replenishing operation of the fluid F1 to the fluid tank 17 can be substantially eliminated. The fluid replenishing unit described in the description of the second modification can be applied to the vibration transmission damping apparatus 1a according to the first modification.

Third Modification

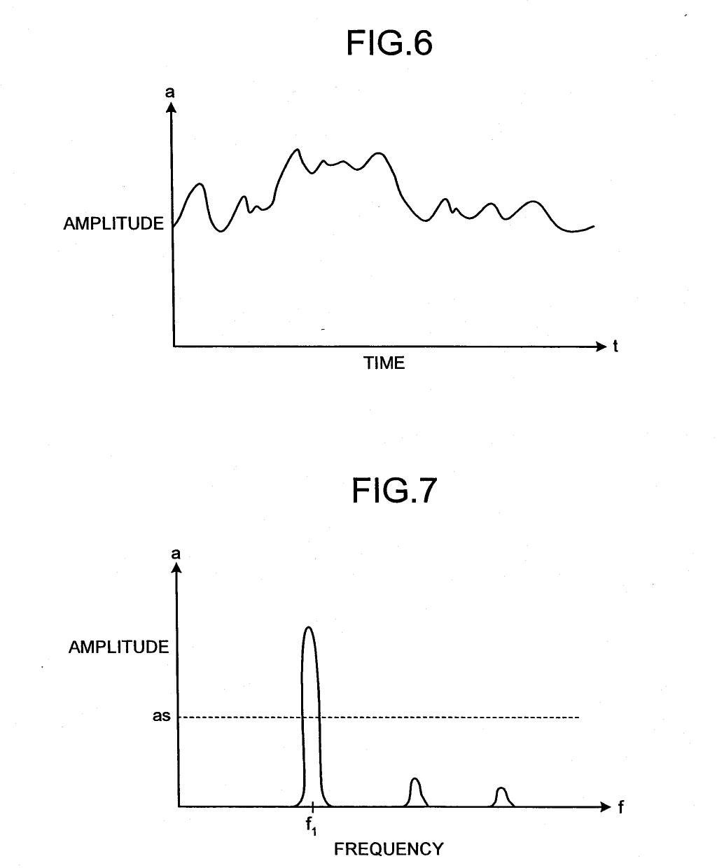

FIG. 4 is a schematic diagram of a vibration transmission damping apparatus of a third modification of the first embodiment. A vibration transmission damping apparatus 1c of the third modification has substantially the same structure as the vibration transmission damping apparatus 1b of the second modification of the first embodiment (FIG. 3). The vibration transmission damping apparatus 1c is different from the vibration transmission damping apparatus 1b in that the on-off valve 8V of the fluid-path opening/closing unit 8 is opened/closed based on the vibrations detected by a vibration detector. The vibration transmission damping apparatus 1c may not include the fluid replenishing unit configured with the fluid tank 17, the fluid supply tube 16, the fluid supply valve 18, and the fluid supply controller 50.

The vibration transmission damping apparatus 1c of the third modification includes a vibration detection sensor (accelerometer, for example) 53 as a frequency detector. The vibration detection sensor 53 is attached to the structural-object supporting member 11 and detects the vibrations of the structural-object supporting member 11. A vibration transmission damping controller 51, which is configured with a CPU, a memory or the like, determines the frequency of the vibration whose transmission is to be damped by the vibration transmission damping apparatus 1c based on the vibrations of the structural-object supporting member 11 acquired from the vibration detection sensor 53.

For example, assume that the frequency of the vibration whose transmission is to be damped by the vibration transmission damping apparatus 1c is a frequency of a vibrational component which has the largest vibration energy among the vibrational components of the structural-object supporting member 11. The vibration transmission damping apparatus 1c of the third modification can adaptively damp the transmission of the vibration even when the type of the structural object 13 supported by the structural-object supporting member 11 and the frequency of the vibration generated by the structural object 13 change. The fluid replenishing unit of the third modification described above can be applied to the vibration transmission damping apparatus 1a according to the first modification.

Fourth Modification

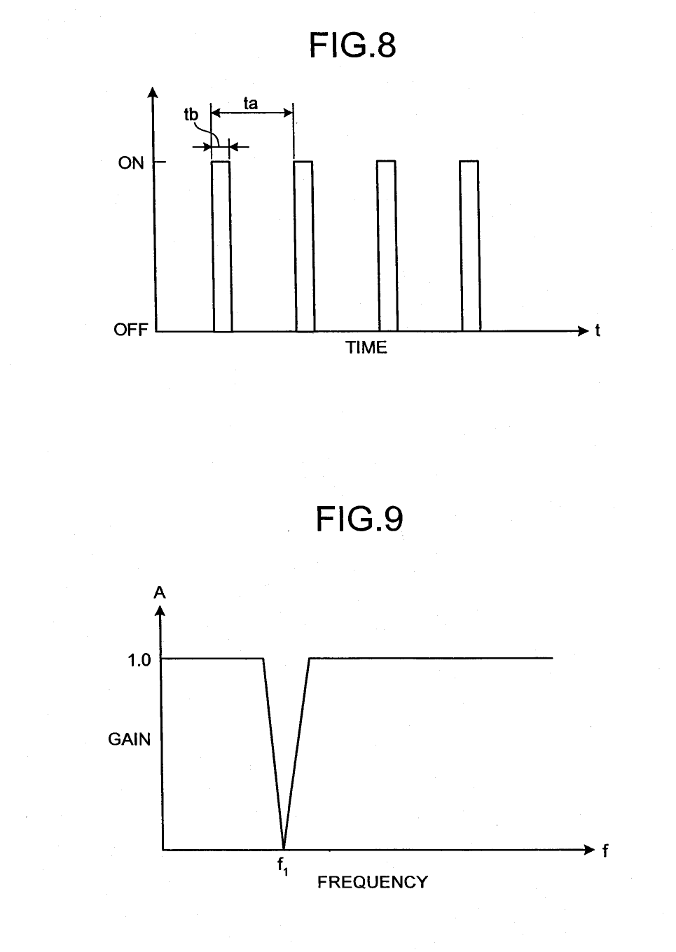

FIG. 5 is a schematic diagram of a vibration transmission damping apparatus of a fourth modification of the first embodiment. In a vibration transmission damping apparatus 1d of the fourth modification, the fluid chamber 4 in the cylinder 2 is divided into a first fluid chamber 4A and a second fluid chamber 4B separated by the piston 3. The first fluid chamber 4A and the second fluid chamber 4B are connected by the fluid passage 7, and the fluid-path opening/closing unit 8 is provided in the fluid passage 7. Further, an air spring 6 is arranged between the cylinder 2 and the structural-object supporting member 11 as a supporting member which supports the structural-object supporting member 11. In the fourth modification, the fluid filling the first fluid chamber 4A and the second fluid chamber 4B is gaseous matter (air), which is the same as gaseous matter (air) filling the air spring 6. The first fluid chamber 4A and the second fluid chamber 4B may be configured with an elastic body such as rubber.

Further, a sealing member 9A is arranged between the piston 3 and the cylinder 2 so as to maintain the air-tightness of the first fluid chamber 4A and the second fluid chamber 4B. Further, since the connecting member 12 connecting the piston 3 and the structural-object supporting member 11 penetrates through the cylinder 2 at the side of the structural-object supporting member 11, a sealing member 9B is arranged between the connecting member 12 and the cylinder 2 so as to maintain the air-tightness of the first fluid chamber 4A.

The vibration transmission damping apparatus 1d of the fourth modification forms an air spring with the first fluid chamber 4A and the second fluid chamber 4B. By makes the on-off valve 8V open/close at a frequency of a vibration whose transmission is to be damped, the air spring allows the vibration transmission damping apparatus 1d to exert the function of damping the transmission of vibration of such frequency. In the vibration transmission damping apparatus 1d, the weight of the structural object 13 and the structural-object supporting member 11 is supported by forces defined by the pressure in the air spring 6 and the pressure in the second fluid chamber 4B, subtracted by a force caused by the pressure inside the first fluid chamber 4A. By changing the level of each pressure dybamically over time, the vibration transmission damping apparatus 1d can have a frequency-selective characteristic.

When the vibration transmission damping apparatus 1d of the fourth modification is to damp the transmission of vibrations, the on-off valve 8V is made to open/close at the frequency of the vibration whose transmission is to be damped as described above. Since the fluid F1 moves between the first fluid chamber 4A and the second fluid chamber 4B during the damping operation, the fluid filling the first and the second fluid chambers 4A and 4B is not discharged outside. Hence, there is no need to replenish the fluid in the first and the second fluid chambers 4A and 4B, and the operating time of the vibration transmission damping apparatus 1d is not restricted by the decrease in the amount of the fluid.

The vibration transmission damping apparatus 1d includes a fluid replenishing unit which supplies the fluid (air) F1 to the air spring 6 and the fluid chamber 4 (second fluid chamber 4B). Thus, the sustained load of the vibration transmission damping apparatus 1d and the air spring 6 can be changed, and the fluid F1 that leaks out through the sealing members 9A and 9B can be replenished. The fluid replenishing unit includes the fluid tank 17, the fluid supply tube 16, the fluid supply valve 18, a fluid supply valve 19, and the fluid supply controller 50.

Though the vibration transmission damping apparatus 1d of the fourth modification includes the vibration detection sensor 53 and the vibration transmission damping controller 51 provided in the vibration transmission damping apparatus 1c of the third modification, these components can be eliminated from the vibration transmission damping apparatus 1d. An example of a procedure of vibration transmission damping control performed with the vibration detection sensor 53 and the vibration transmission damping controller 51 will be described below. In the following, an example of the vibration transmission damping control in the vibration transmission damping apparatus 1d of the fourth modification will be described. The same operation can be performed in the vibration transmission damping apparatus 1c (see FIG. 4) of the third modification.

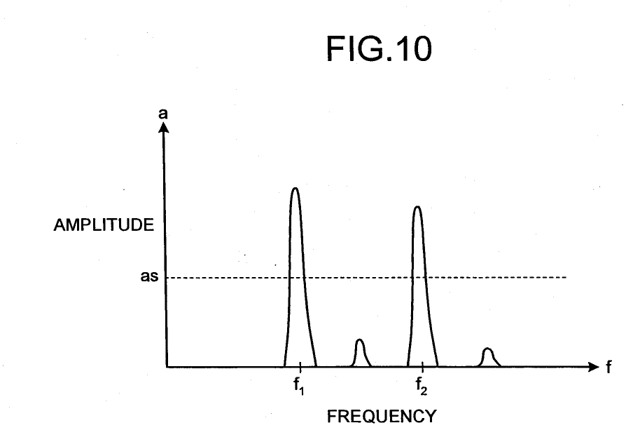

FIGS. 6 to 9 are graphs illustrating an exemplary procedure of vibration transmission damping according to the first embodiment. In an example described below, the vibration transmission damping apparatus 1d of the fourth modification performs vibration transmission damping control to damp the transmission of vibrations from the structural object 13 supported by the vibration transmission damping apparatus 1d to the base B. As an example, it is described that the transmission of a vibration component having a frequency whose (power) amplitude exceeds a predetermined threshold “as” is damped among the vibration components of the structural object 13. In the following a frequency of the largest (power) amplitude will be referred to as a dominant frequency, while a frequency above the (power) threshold “as” will be referred to as an outstanding frequency considering the possibility that there are more than 1 frequency exceeding the threshold “as”.

The vibration transmission damping controller 51 sets the frequency (outstanding frequency) of vibration whose transmission is to be blocked by the vibration transmission damping apparatus 1d. In the first embodiment, the vibration transmission damping controller 51 acquires the vibrational components of the structural object 13 supported by the structural-object supporting member 11 based on the acceleration of the structural-object supporting member 11 acquired from the vibration detection sensor 53. The acquired vibrational components of the structural object 13 can be shown as in FIG. 6, for example.

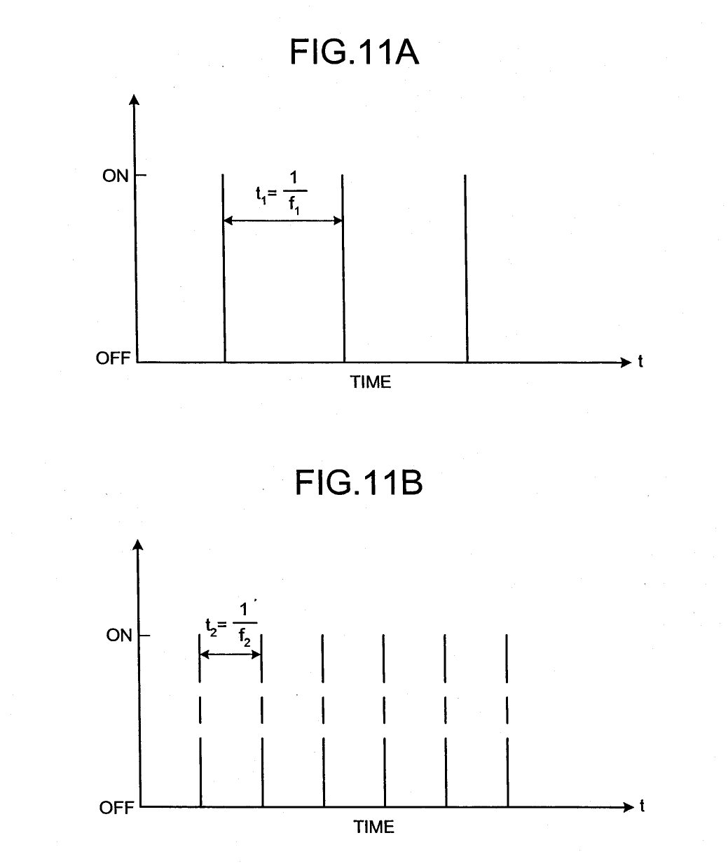

Then, the vibration transmission damping controller 51 performs Fourier analysis on the acquired vibrational components. An explanatory result of Fourier analysis is shown in FIG. 7. In the figure, the horizontal axis indicates frequency component and the vertical axis represents the power of each frequency component, namely time average of the square of the amplitude. The vibration transmission damping controller 51 determines the outstanding frequency based on the result of Fourier analysis. In the first embodiment, the outstanding frequency is a frequency whose amplitude is above the predetermined threshold “as”. In the example shown in FIG. 7, the outstanding frequency is f₁.

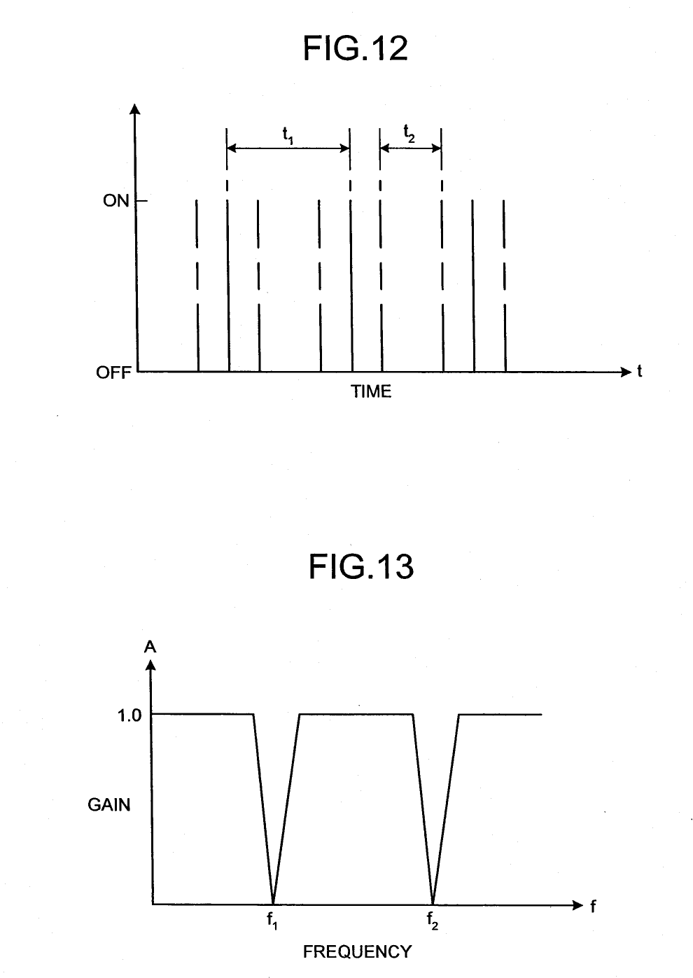

After setting the outstanding frequency, the vibration transmission damping controller 51 sets an opening/closing frequency f₀ of the fluid-path opening/closing unit 8 to the outstanding frequency itself, or an integral multiple of the outstanding frequency, or a frequency obtained by diving the outstanding frequency by an integer. An example of a valve-opening command pulse is shown in FIG. 8. As shown in FIG. 8, the period of the valve-opening command pulse is ta. When the outstanding frequency itself is the opening/closing frequency fo, the expression, fo=f₁=(1/ta) is satisfied. The vibration transmission damping controller 51 can set the pulse width tb (see FIG. 8) of the valve-opening command pulse based on the amplitude of the vibration of the outstanding frequency or based on the sustained load of the vibration transmission damping apparatus 1d. The pulse width tb of the valve-opening command pulse indicates the time the on-off valve 8V remains open, i.e., the communicating time of the fluid passage 7, which will be referred to as “valve-opening time” hereinbelow. It is desirable that the valve-opening time tb be made smaller as the sustained load of the vibration transmission damping apparatus 1 increases.

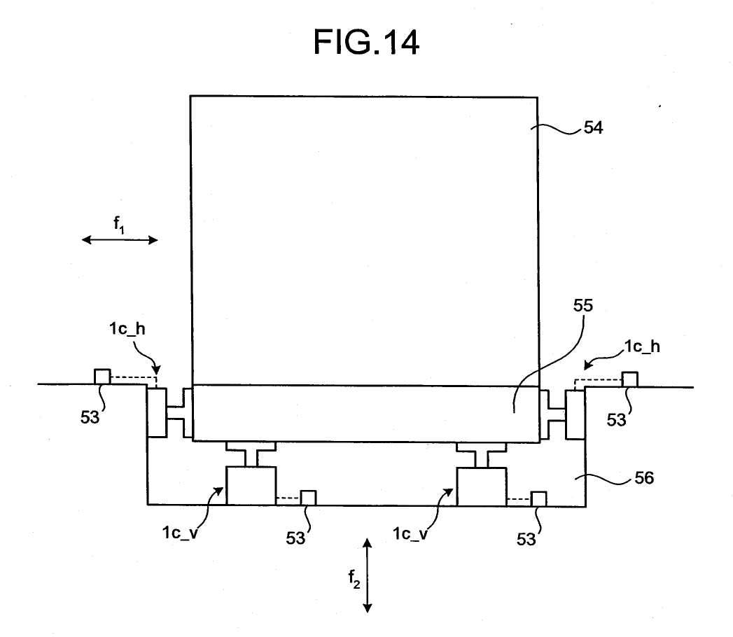

The vibration transmission damping controller 51 outputs the valve-opening command pulse to the actuator 8A of the fluid-path opening/closing unit 8 at the set opening/closing frequency f₀(=1/ta) using the valve-opening time tb as the pulse width of the valve-opening command pulse. Thus, the vibration transmission damping apparatus 1d works as a frequency filter which has a gain of zero at the outstanding frequency f₁ and a gain of approximately 1.0 at frequencies other than the outstanding frequency as shown in FIG. 9. More specifically, the vibrations of the outstanding frequency f₁ are blocked by the vibration transmission damping apparatus 1d and would not be transmitted to the base B substantially. Thus, the transmission of the vibrations of the outstanding frequency f₁ to the base B can be damped.

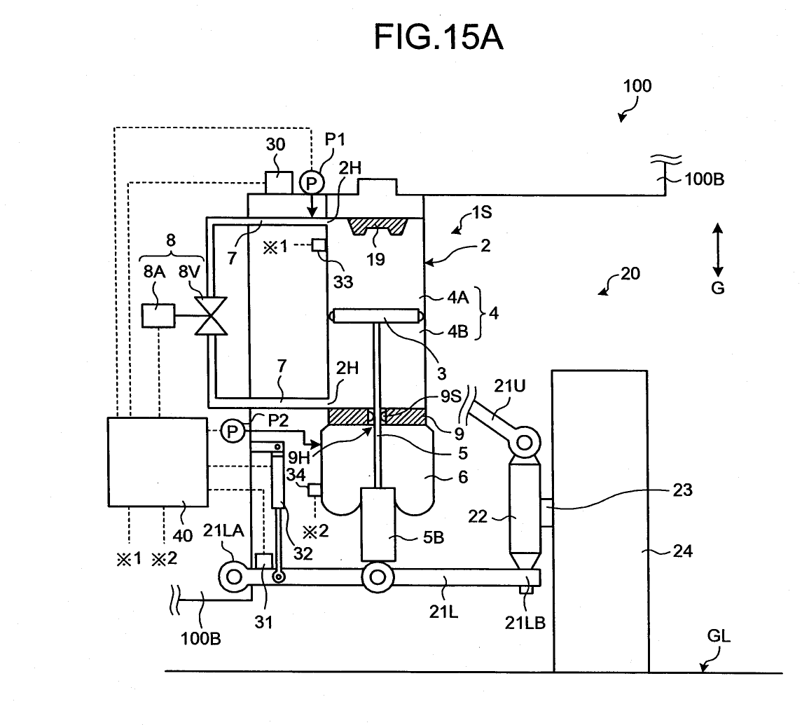

FIGS. 10 to 13 are graphs illustrating another exemplary procedure of the vibration transmission damping control according to the first embodiment. In the following description, it will be described how the transmission of vibrational components of plural outstanding frequencies (two frequencies in the following example) among vibrational components of the structural object 13 is damped by the control operation of the vibration transmission damping apparatus 1d of the fourth modification.

The vibration transmission damping controller 51 sets a frequency (outstanding frequency) of vibrations whose transmission to the base B is to be damped. The vibration transmission damping controller 51 performs Fourier analysis of the vibrations of the structural object 13. Result of Fourier analysis is shown in FIG. 10. The vibration transmission damping controller 51 determines the outstanding frequency based on the result of Fourier analysis. In the first embodiment, the outstanding frequency is a frequency whose amplitude is above the predetermined threshold “as”. In the example shown in FIG. 10, the outstanding frequencies are f₁ and f₂.

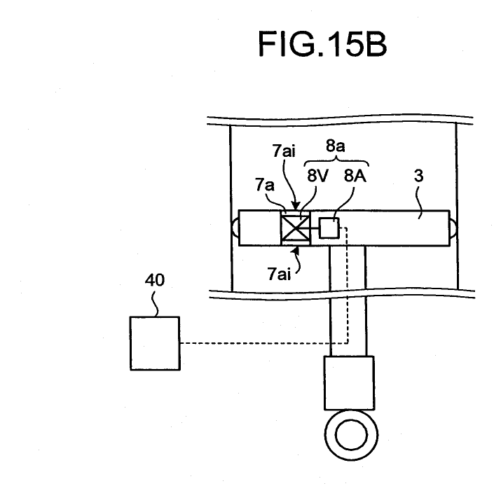

After setting the level of the outstanding frequency, the vibration transmission damping controller 51 sets the valve-opening command pulse of the fluid-path opening/closing unit 8. An example of the valve-opening command pulse is shown in FIGS. 11A and 11B. FIG. 11A is a graph of a valve-opening command pulse for the outstanding frequency f₁, whereas FIG. 11B is a graph of a valve-opening command pulse for the outstanding frequency f₂. As shown in FIG. 11A, the pulse period t₁ of the valve-opening command pulse for the outstanding frequency f₁ can be expressed as f₁=(1/t₁). As shown in FIG. 11B, the pulse period t₂ of the valve-opening command pulse for the outstanding frequency f₂ can be expressed as f₂=(1/t₂).

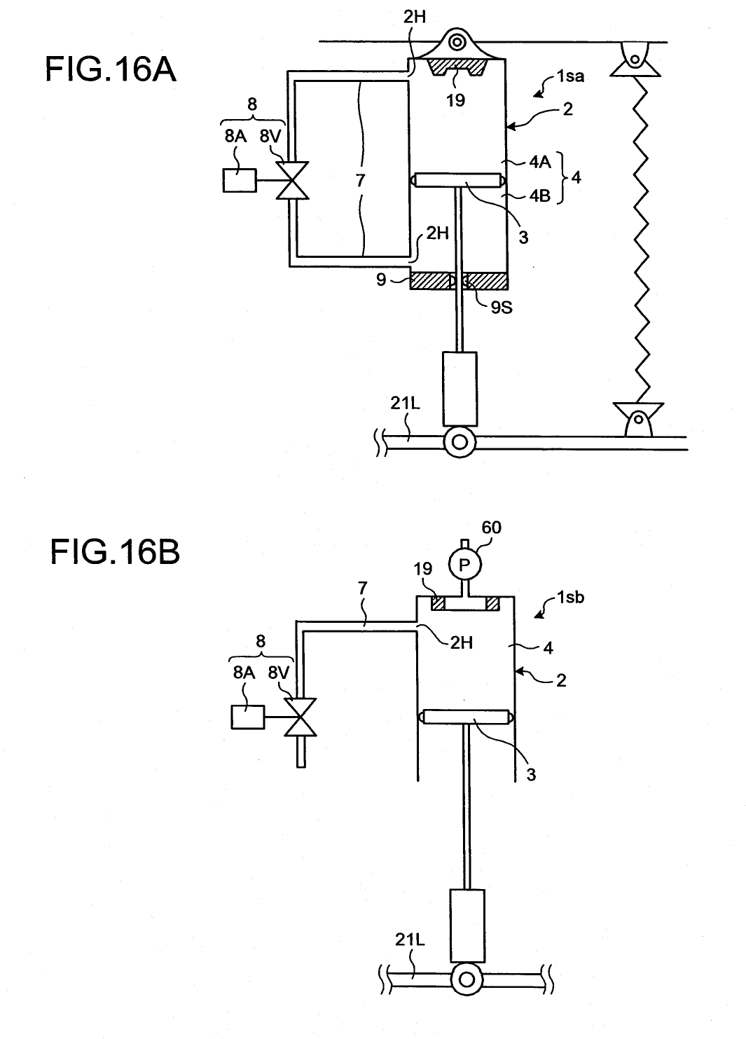

On damping the vibrational components of plural outstanding frequencies, the vibration transmission damping controller 51 employs a combination of the valve-opening command pulse for the outstanding frequency f₁ and the valve-opening command pulse for the outstanding frequency f₂ as a valve-opening command pulse sequence, as shown in FIG. 12. A solid line in FIG. 12 indicates the valve-opening command pulse for the outstanding frequency f₁, and a dashed line indicates the valve-opening command pulse for the outstanding frequency f₂.

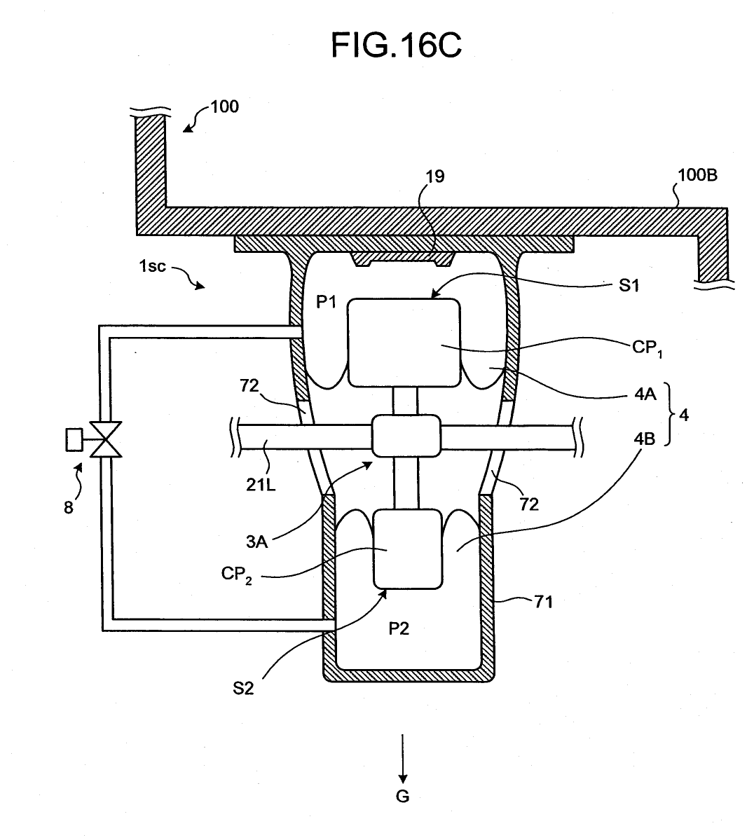

The vibration transmission damping controller 51 outputs the set valve-opening command pulse sequence as the valve-opening command pulse to the actuator 8A of the fluid-path opening/closing unit 8 by setting the pulse width to the valve-opening time tb (see FIG. 8). Thus, the vibration transmission damping apparatus 1d works as a frequency filter which has a gain of zero at the outstanding frequencies f₁ and f₂ and a gain of approximately 1.0 at frequencies other than the outstanding frequencies as shown in FIG. 13. More specifically, the vibrations of the outstanding frequencies f₁ and f₂ are blocked by the vibration transmission damping apparatus 1d and would not be transmitted to the base B substantially. Thus, the transmission of the vibrations of the outstanding frequencies f₁ and f₂ can be damped. As described above, the vibration transmission damping apparatus 1d can block the vibrations of plural frequencies by setting plural outstanding frequencies. Therefore, the vibration transmission damping apparatus 1d can damp the transmission of vibrations of wider frequency ranges to the base B.

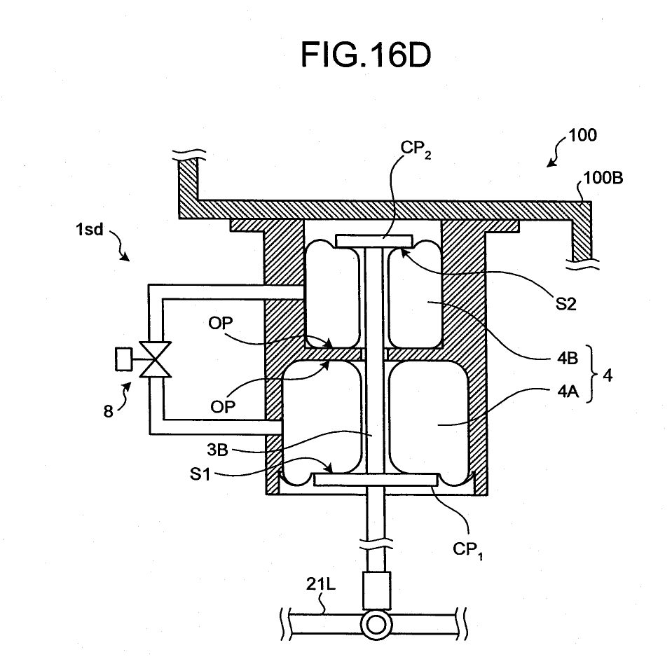

FIG. 14 is a schematic diagram of an application of the vibration transmission damping apparatus according to the first embodiment. FIG. 14 shows an exemplary application of the vibration transmission damping apparatus 1c of the third modification of the first embodiment, where the vibration transmission damping apparatus 1c is installed to an apparatus which includes a vibration source that generates vibration having a horizontal dominent frequency f₁ and a vertical dominent frequency f₂. An apparatus 54 has a base 55 which is placed within a trench 56 and supported by vibration transmission damping apparatuses 1c_v and 1c_h arranged in the trench 56. The vibration transmission damping apparatus 1c_v and the vibration transmission damping apparatus 1c_h supporting the base 55 serve to damp the transmission of vibration in a direction parallel to a vertical direction (direction the gravity is applied) and in a horizontal direction (direction orthogonal to the vertical direction), respectively.

The vibration transmission damping apparatuses 1c_v and 1c_h are installed in such a manner that the vibrations generated by a structural object including the apparatus 54 and the base 55 do not propagate to the surroundings. Conventionally, when it is desirable to damp the transmission of vibrations generated from apparatuses and machines that generate large amount of vibrations, a trench is made down to the bedrock and the apparatus or the machine is supported by piles anchored in the bedrock so that the vibrations do not propagate to the surroundings. The vibration transmission damping apparatuses 1c_v and 1c_h of the first embodiment can eliminate the needs of anchoring the piles in the bedrock, whereby the cost can be reduced.

The vibration transmission damping apparatuses 1 to 1d of the first embodiment and the modifications thereof can be applied to objects other than the one described above. The vibration transmission damping apparatuses 1 to 1d can be applied, for example, to suspension systems of general vehicles such as bicycles, two-wheel vehicles, trucks, buses, suspension systems of general railroad vehicles such as trains and locomotives, buffer systems such as yaw dampers employed in wheels of airplanes, vibration control mechanisms and vibration absorbing mechanisms for cameras, Video Tape Recorders (VTRs), optical disc drives, and the like, and vibration control mechanisms, seismic isolation mechanisms, and the like for various equipments.

As can be seen from the foregoing, according to the first embodiment and the modifications thereof, a fluid chamber is filled with a fluid and is arranged between a vibration source and a structural object which is to be blocked from the transmission of the vibration, and further, a fluid-path opening/closing unit is arranged in a fluid path which communicates an interior of the fluid chamber and an exterior of the fluid chamber so as to open/close the fluid path at a specific frequency. Thus, the transmission of vibrations of a specific frequency to a supported structural object and the transmission of vibrations of a specific frequency generated by the structural object can be damped. Apparatuses having the same structure as the one described hereinabove have the same effects and advantages as the first embodiment.

### Second Embodiment

In a second embodiment, the vibration transmission damping apparatus of the first embodiment is applied to a suspension system of a vehicle. An apparatus according to the second embodiment periodically opens/closes a fluid passage connected to a fluid chamber that is filled with a fluid (gaseous matter) such as air and nitrogen to support the load, releases part of the gaseous matter filling the fluid chamber into the air or into another fluid chamber, and makes a spring stiffness of the fluid chamber decrease with respect to an external force having the same period as the frequency of opening/closing operation of the fluid passage, so as to utilize this characteristic. Thus, even when the natural frequency of a vibration system varies, an effect of vibration damping can be exerted with respect to the supported mass (mass of the structural object, i.e., vehicle body). In the description, when the fluid is described as being “released”, it means that the gaseous matter in the fluid chamber is discharged outside the fluid chamber when there is only one fluid chamber, and that the gaseous matter in a high-pressure side fluid chamber moves to a low-pressure side fluid chamber when there are two fluid chambers separated by a vibration input unit (such as a piston).

When there is only one fluid chamber that supports the load (i.e., the mass of the vehicle body), a fluid-path opening/closing unit (on-off valve, for example) is arranged in the fluid passage for discharging the fluid (gaseous matter) filling the fluid chamber to the outside, and is made to open/close at a specific frequency corresponding to the frequency of vibrations of the supported mass (i.e., the mass of the vehicle body) so as to release part of the gaseous matter in the fluid chamber to the outside of the fluid chamber.

When there are two fluid chambers that support the load, the apparatus is provided with two fluid chambers filled with a fluid (gaseous matter) for supporting the load, a vibration input unit that inputs the vibrations into two fluid chambers by reciprocating relative to two fluid chambers, a fluid passage that communicates two fluid chambers with each other, and a fluid-path opening/closing unit (e.g., on-off valve) arranged in the fluid passage. The fluid-path opening/closing unit is opened/closed at specific frequency corresponding to the frequency of the reciprocating movements of the vibration input unit relative to two fluid chambers.

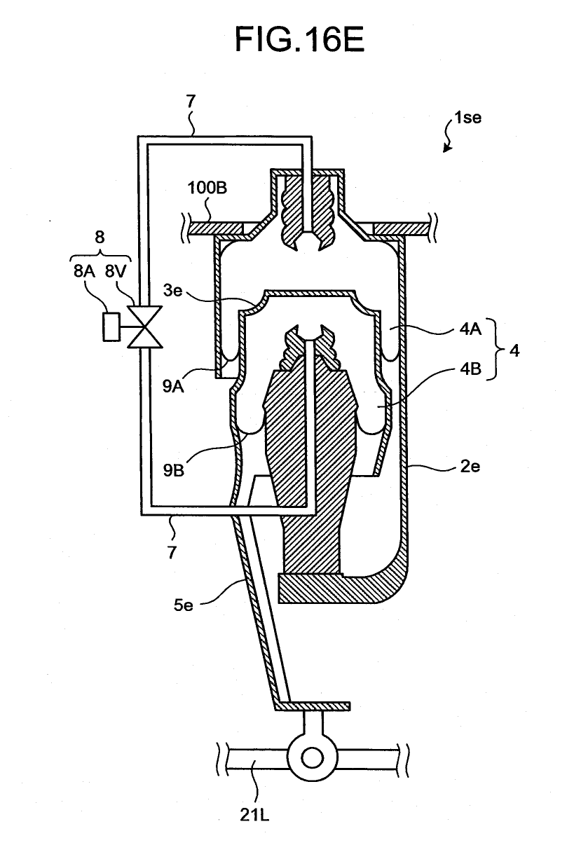

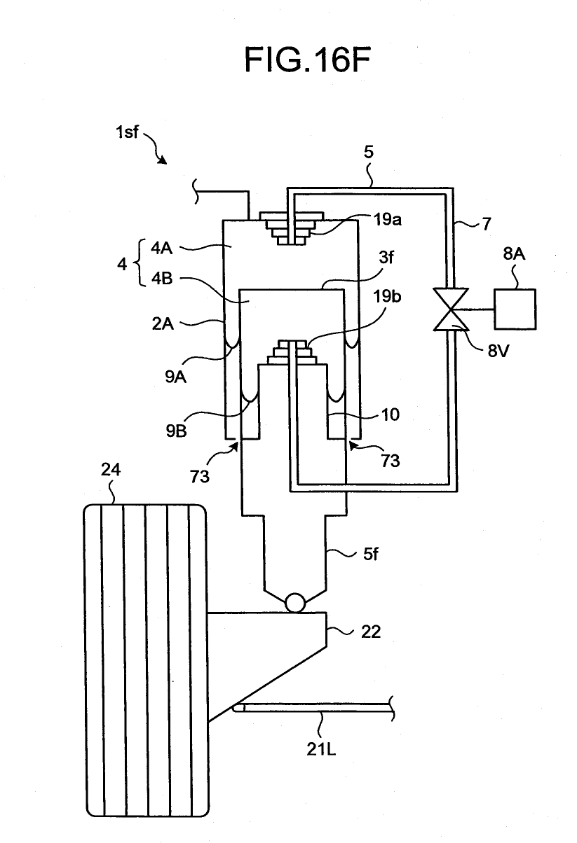

FIG. 15A is a schematic diagram of a structure of a vehicle-body supporting apparatus according to the second embodiment of the present invention. FIG. 15A shows an exemplary application of a vehicle-body supporting apparatus (vibration transmission damping apparatus) 1S of the second embodiment to a suspension system 20 of a vehicle 100. FIG. 15B is a schematic diagram of another example of the fluid-path opening/closing unit. FIGS. 16A to 16D are schematic diagrams of another example of the structure of the vehicle-body supporting apparatus according to the second embodiment of the present invention. The vehicle-body supporting apparatus 1S according to the second embodiment works as a structure including a buffer apparatus for the suspension system 20 of the vehicle 100, i.e., a spring and a vibration damping unit (e.g., damper). The structural object which is supported by the vehicle-body supporting apparatus 1S according to the second embodiment is a vehicle body 100B of the vehicle 100.

The vehicle-body supporting apparatus 1S includes the cylinder 2, the piston 3 which is arranged inside the cylinder 2 so as to reciprocate, a fluid passage 7, a fluid-passing hole 2H which communicates the fluid passage 7 with the inside of the cylinder 2, and a fluid-path opening/closing unit 8 which is arranged in the fluid passage 7. Here, the fluid path is configured with the fluid passage 7 and the fluid-passing hole 2H. The cylinder 2 has the fluid chamber 4 inside. The fluid chamber 4 is filled with a fluid (gaseous matter, or more specifically, air in the second embodiment) pressurized to a predetermined pressure. Alternatively, a pressure adjuster such as a pump may be attached to the fluid chamber 4, so that the pressure level of the gaseous matter filling the fluid chamber 4 can be adjusted according to the variations in mass of the vehicle 100 or the running condition.

The fluid chamber 4 is divided into the first fluid chamber 4A and the second fluid chamber 4B by the piston 3. The piston 3 works as a vibration input unit which inputs the vibrations of an object (in the second embodiment, the vehicle body 100B of the vehicle 100 and the lower arm 21L of the suspension system 20), to which the vehicle-body supporting apparatus 1S is attached, to the fluid chamber 4 (first fluid chamber 4A and second fluid chamber 4B) by reciprocating relative to the fluid chamber 4. The first and the second fluid chambers 4A and 4B may be configured as separate members made of flexible material such as fiber-reinforced rubber sheet, and the piston 3 may be placed between the first and the second fluid chambers 4A and 4B.

The piston rod 5 is attached to the piston 3. The piston rod 5 has one end provided with a bracket 5B which is attached to the lower arm 21L of the suspension system 20 to which the vehicle-body supporting apparatus 1S is attached. The piston 3 is connected to the lower arm 21L of the suspension system 20 via the piston rod 5 and the bracket 5B. When the lower arm 21L moves in a direction of an arrow G shown in FIG. 15A, the piston 3 reciprocates inside the cylinder 2 in conjunction with the lower arm 21L.

As shown in FIG. 15A, a vehicle-body acceleration sensor 30 is attached to the vehicle body 100B of the vehicle 100. The vehicle-body acceleration sensor 30 can detect acceleration of the vehicle body 100B in a direction orthogonal to a road surface GL (i.e., acceleration of a portion of the vehicle 100 above the spring). Based on the detected acceleration, the frequency of the vibrations of the portion above the spring can be found. Further, a suspension-system acceleration sensor 31 is attached to the lower arm 21L of the suspension system 20. The suspension-system acceleration sensor 31 can detect the movements of the lower arm 21L so as to find the acceleration of a portion of the vehicle 100 under the spring in the direction orthogonal to the road surface GL. Based on the found acceleration, the frequency of the vibrations of the portion under the spring can be found. Thus, each of the vehicle-body acceleration sensor 30 and the suspension-system acceleration sensor 31 works as a vibration detector. More specifically, the vehicle-body acceleration sensor 30 works as a sprung vibration detector which detects the vibrations of the portion of the vehicle 100 above the spring, whereas the suspension-system acceleration sensor 31 works as an unsprung vibration detector which detects the vibrations of a portion of the vehicle 100 under the spring.

Further, a stroke sensor 32 is attached to the lower arm 21L of the suspension system 20. The stroke sensor 32 allows for the detection of the vehicle level of the vehicle 100. The stroke sensor 32 also provides information on the stroke of the vehicle-body supporting apparatus 1S. Therefore, the vehicle level of the vehicle 100 can be maintained at a fixed level through replenishment of air in the fluid chamber 4 or in the air spring 6 described later, or through the discharge of the air from the air spring 6 and the like, even when the passenger of the vehicle changes or the load of the vehicle 100 changes so as to cause the variations in vehicle level.

As shown in FIG. 15A, a first pump P1 may be connected to the fluid passage 7 connected to the fluid chamber 4 so as to work as a fluid supply unit for the fluid chamber 4. It is desirable that a second pump P2 be connected to the air spring 6 as the fluid supply unit. Further, the vehicle-body supporting apparatus 1S may include a fluid-chamber pressure sensor 33 which measures the pressure in the fluid chamber 4, and an air-spring pressure sensor 34 which measures the pressure inside the air spring 6. Since the volume of the air spring 6 can be found based on the value detected by the stroke sensor 32, the amount of air in the air spring 6 can be known based on the detected value of the stroke sensor 32 and the pressure in the air spring 6 as acquired from the air-spring pressure sensor 34. Thus, the amount of gaseous matter filling the fluid chamber 4 or the air spring 6 can be known with the use of the fluid-chamber pressure sensor 33, the stroke sensor 32, and the air-spring pressure sensor 34 as a fluid-amount detector.

When the detected amount of the gaseous matter in the fluid chamber 4 or the detected amount of the gaseous matter in the air spring 6 is equal to or below a predetermined threshold value, the vehicle-body supporting apparatus 1S is unable to maintain the vehicle level of the vehicle body 100B at a predetermined level. In this case, the gaseous matter is replenished to the fluid chamber 4 or the air spring 6 via the first pump P1 or the second pump P2. In this way, the vehicle-body supporting apparatus 1S can remain able to maintain the vehicle level of the vehicle body 100B so as to realize safe running of the vehicle 100.

A bottom plate 9 is attached as a sealing member to a portion of the cylinder 2 where the piston rod 5 protrudes. The piston rod 5 runs through a through hole 9H of the bottom plate 9. A sealing member 9S is attached to the through hole 9H, so as to minimize the amount of the gaseous matter leaking out from the second fluid chamber 4B through the gap formed between the piston rod 5 and the through hole 9H.

In the second embodiment, the elastic air spring 6 is arranged between the bracket 5B and the bottom plate 9 (i.e., between the bracket 5B and the second fluid chamber 4B) so as to work as a third fluid chamber. A main function of the air spring configured with the first fluid chamber 4A and the second fluid chamber 4B of the vehicle-body supporting apparatus 1S is to give the vehicle-body supporting apparatus 1S frequency selective characteristics. The vehicle-body supporting apparatus 1S supports the mass of the vehicle body 100B with a force expressed as a difference between load bearing force of the pressure inside the air spring 6 and the pressure inside the first fluid chamber 4A, and a force of the pressure inside the second fluid chamber 4B. Here, the air spring 6 may be replaced with a different elastic body such as a coil spring and a leaf spring, so as to support the load of the vehicle body 100B.

Even when the vehicle-body supporting apparatus 1sa itself does not have the air spring 6 (see FIG. 15A) as in the case of the vehicle-body supporting apparatus 1sa shown in FIG. 16A, the mass of the vehicle body 100B to which the vehicle-body supporting apparatus 1S is attached can be supported. Further, when a different type of elastic body (e.g., coil spring) is employed, and a pump 60 serving as a fluid supply unit supplies the gaseous matter to the fluid chamber 4 in real time as in the vehicle-body supporting apparatus 1sb shown in FIG. 16B so as to maintain the pressure inside the fluid chamber 4 at a predetermined level, a single fluid chamber 4 may be sufficient and an additional spring mechanism may not be necessary.

Further, a stopper member 19 is arranged inside the vehicle-body supporting apparatuses 1S, 1sa, and the like of the second embodiment at a position opposite to the piston 3 at the attachment side of the vehicle body. In this case, the stopper member 19 can support the sprung mass even when the air in the air spring 6, the fluid chamber 4A, and the like comes out to disable the supporting of the sprung mass of the vehicle 100 by the air pressure. Thus, even when the air leakage occurs in the air spring 6 and the first fluid chamber 4A, the stopper member 19 directly contacts with the piston 3 so as to support the mass of the vehicle body 100B. Therefore, the vehicle body 100B can run at least at low speed. As a result, even when the air leakage occurs in the air spring 6 or the first fluid chamber 4A, the vehicle 100 can run slowly until arriving at a repair shop or the like.

The lower arm 21L which forms a part of the suspension system 20 of the vehicle 100 has a first end 21LA attached to the vehicle body 100B and a second end 21LB to which a wheel bracket 22 for the attachment of a wheel 24 is attached. The wheel 24 is attached to the wheel bracket 22 via an axle shaft 23. The wheel bracket 22 is attached to the vehicle body 100B via the lower arm 21L and an upper arm 21U (an attachment of the upper arm 21U to the vehicle body is not shown).

The vehicle-body supporting apparatus 1S and the lower arm 21L of the suspension system 20 are connected with each other via the bracket 5B attached to the piston rod 5 of the vehicle-body supporting apparatus 1S. When the wheel 24 moves in the direction of arrow G due to shocks from the road surface GL or the like, the lower arm 21L swings about the first end 21LA. Then, the piston 3 of the vehicle-body supporting apparatus 1S reciprocates in the cylinder 2 in conjunction with the lower arm 21L.

According to the reciprocation of the piston 3, the volumes of the first fluid chamber 4A and the second fluid chamber 4B change. For example, when the lower arm 21L moves up to make the total length of the vehicle-body supporting apparatus 1S shorter, the piston 3 moves upward accordingly. In this case, the volume of the first fluid chamber 4A decreases, while the volume of the second fluid chamber 4B increases. Thus, the first fluid chamber 4A and the second fluid chamber 4B generate a force (i.e., repulsive force) to push back the piston 3 in a direction opposite to the moving direction of the piston 3. Thus, the vehicle-body supporting apparatus 1S works as an air spring so as to absorb the shocks applied to the wheel 24 from the road surface GL and to support the mass of the vehicle body 100B.

In the second embodiment, the first fluid chamber 4A and the second fluid chamber 4B are connected with each other via the fluid passage 7 through which the gaseous matter filling the first and the second fluid chambers 4A and 4B passes. Further, the on-off valve 8V is provided in the fluid passage 7 so as to form the fluid-path opening/closing unit 8. Specifically, the on-off valve 8V is arranged between the first fluid chamber 4A and the second fluid chamber 4B. The fluid-path opening/closing unit 8 includes the on-off valve 8V, the actuator 8A (e.g., solenoid, piezoelectric element such as piezo element, and ultrasonic motor) which opens/closes the on-off valve 8V under the control of a vibration controller 40. When the actuator 8A closes the on-off valve 8V, the first fluid chamber 4A is cut off from the second fluid chamber 4B, so that the gaseous matter cannot move between the first and the second fluid chambers 4A and 4B. On the other hand, when the actuator 8A opens the on-off valve 8V, the first fluid chamber 4A is communicated with the second fluid chamber 4B, so that the gaseous matter can move between the first fluid chamber 4A and the second fluid chamber 4B via the fluid passage 7.

Here, the fluid-path opening/closing unit 8a may be provided in a communicating hole 7a of the piston 3 as shown in FIG. 15B. In this case, the communicating hole 7a and a communicating-hole mouth (corresponding to the fluid-passing hole) 7ai serve as the fluid path. When the fluid-path opening/closing unit 8a is embedded in and attached to the piston 3 or the piston rod 5 as described above, the fluid-path opening/closing unit and the fluid passage 7 (see FIG. 15A) do not need to be provided outside the vehicle-body supporting apparatus 1S, whereby the vehicle-body supporting apparatus 1S can be made compact. Further, since the fluid passage connecting the first fluid chamber 4A and the second fluid chamber 4B is not arranged outside the vehicle-body supporting apparatus 1S, the fluid passage would not be damaged by pebbles or the like while the vehicle 100 is running, whereby the vehicle-body supporting apparatus 1S can enjoy an enhanced reliability.

The vehicle-body supporting apparatus 1S of the second embodiment damps the transmission of vibrations of a notch frequency to the vehicle body 100B by working as a notch filter which decreases the spring stiffness with respect to the vibrations of the notch frequency. Thus, the vehicle-body supporting apparatus 1S can avoid resonance amplification in the vibration system of the vehicle 100 and prevent transmission of uncomfortable vibrations to the vehicle body 100B. As described above, the vehicle-body supporting apparatus 1S of the second embodiment has an effect of damping the transmission of vibrations to the vehicle body 100B. In other words, the vehicle-body supporting apparatus 1S of the second embodiment has an effect like a vibration attenuation apparatus.

The notch filter is a filter having functions of filtering out the vibrations of a specific frequency and allowing the transmission of vibrations of frequencies other than the specific frequency. The vehicle-body supporting apparatus 1S of the second embodiment damps the transmission of vibrations of a specific frequency (or plural prominent frequencies) by working like a notch filter. Specifically, the vehicle-body supporting apparatus 1S damps the transmission of vibrations of a specific frequency (or plural prominent frequencies) between the wheel 24 (see FIG. 15A) and the vehicle body 100B.

Notch frequency is a frequency of vibrations to be filtered out by the notch filter. For example, the notch frequency may be set to the natural frequency of the vibration system of the vehicle 100 which includes the vehicle body 100B and the vehicle-body supporting apparatus 1S. When the vibrations of the natural frequency are transmitted to the vehicle body 100B, the vibrations of the vehicle body 100B are amplified due to resonance (resonance amplification). Therefore, the transmission of such vibrations to the vehicle body 100B needs to be blocked. In other words, the vibrations of the natural frequency are the vibrations of a frequency whose transmission to the vehicle body 100B should be damped desirably. When the notch frequency of the vehicle-body supporting apparatus 1S of the second embodiment is set to the natural frequency, the transmission of the vibrations of the natural frequency to the vehicle body 100B can be damped, whereby the effect of resonance amplification can be suppressed.

To lower the spring stiffness of the vehicle-body supporting apparatus 1S with respect to the vibrations of the notch frequency, what is necessary is to open/close the fluid-path opening/closing unit 8 not only at the notch frequency (specific frequency corresponding to the frequency of the reciprocation of the piston 3 relative to the fluid chamber 4) but also at a harmonic frequency which is the integral multiple of the notch frequency, or at a frequency obtained by dividing the notch frequency by an integer according to the theory of Fourier expansion. Thus, the vehicle-body supporting apparatus 1S of the second embodiment supports the load with a lower transmissibility for the notch frequency while maintaining a relatively high transmissibility, in comparison with that for the notch frequency, for frequencies other than the notch frequency. Such a characteristic is particularly important for supporting a static load (for which the vibrational frequency corresponds to zero).

A vehicle-body supporting apparatuses shown in FIGS. 16C and 16D will be described. A vehicle-body supporting apparatus 1sc shown in FIG. 16C includes the first fluid chamber 4A and the second fluid chamber 4B filled with gaseous matter and arranged opposite to each other. The first and the second fluid chambers 4A and 4B are housed in a case (casing) 71. In the second embodiment, the first fluid chamber 4A is arranged at the side of the vehicle body 100B of the vehicle 100 to which the vehicle-body supporting apparatus 1sc is attached. The second fluid chamber 4B is arranged below the first fluid chamber 4A in a vertical direction. Here, “vertical direction” means a direction of application of gravity, whereas “below” means a side closer to the ground (direction shown by an arrow G in FIG. 16C).

The first fluid chamber 4A and the second fluid chamber 4B arranged opposite to each other are placed so as to sandwich a load-transfer member 3A, which is a vibration input unit, therebetween. To the load-transfer member 3A, the lower arm 21L of the suspension system 20 (see FIG. 15A) is attached. The lower arm 21L runs through a through hole 72 formed in the case 71. The load-transfer member 3A transfers a force transmitted from the road surface via the lower arm 21L to the first fluid chamber 4A and the second fluid chamber 4B. The force transmitted further to the gaseous matter in the first fluid chamber 4A and the second fluid chamber 4B is absorbed and relieved by the compression of the gaseous matter in the first fluid chamber 4A. Thus, the force to be transmitted to the vehicle body 100B is relieved and supported. As can be seen from the above, when the load is applied to the vehicle-body supporting apparatus 1sc, the first fluid chamber 4A and the second fluid chamber 4B undergo opposite volumetric changes. Specifically, when the volume of the first fluid chamber 4A decreases, the volume of the second fluid chamber increases.

Further, as shown in FIG. 16C, a load supporting area S1, which is an area of a portion of the first fluid chamber 4A in contact with a first supporting portion CP₁ of the load-transfer member 3A, is larger than a load supporting area S2, which is an area of a portion of the second fluid chamber 4B in contact with a second supporting portion CP₂ of the load-transfer member 3A (S1>S2). Here, an appropriate ratio of S1 to S2 is approximately 2:1 to 10:1 (the same applies below). Therefore, a pressure-receiving area of the first fluid chamber 4A which receives the pressure from the load-transfer member 3A is larger than a pressure-receiving area of the second fluid chamber 4B which receives the pressure from the load-transfer member 3A.

Thus, a force F1 of the first fluid chamber 4A pushing the load-transfer member 3A is larger than a force F2 of the second fluid chamber 4B pushing the load-transfer member 3A. As a result, the vehicle-body supporting apparatus 1sc alone can support the load transmitted from the lower arm 21L to the load-transfer member 3A without the needs of a separate spring or an air spring for supporting the load. At the same time, the vehicle-body supporting apparatus 1sc can damp the transmission of the vibrations of notch frequency to the vehicle body 100B by opening/closing the fluid-path opening/closing unit 8 at the notch frequency.

In the vehicle-body supporting apparatus 1sc, the load-transfer member 3A is sandwiched between the first fluid chamber 4A and the second fluid chamber 4B arranged opposite to each other. Since the lower arm 21L penetrating the through hole 72 is attached to the load-transfer member 3A and moves through the through hole 72, the vehicle-body supporting apparatus 1sc absorbs and relieves the shock. In conventional buffer apparatuses, a point of action of load is located outside the case. In the vehicle-body supporting apparatus 1sc of the second embodiment, the point of action of load transmitted from the lower arm 21L can be set within the case 71 of the vehicle-body supporting apparatus 1sc. As a result, the entire length of the vehicle-body supporting apparatus 1sc can be made shorter than in the conventional apparatuses. Thus, the suspension system 20 can be made more compact.

Further, as shown in FIG. 16C, the vehicle-body supporting apparatus 1sc includes the stopper member 19 inside the vehicle-body supporting apparatus 1sc at a position opposite to the first supporting portion CP₁ of the load-transfer member 3A at the side where the vehicle is attached. The stopper member 19 is arranged inside the first fluid chamber 4A at the attachment side of the vehicle-body supporting apparatus 1sc to the vehicle body 100B (i.e., inside the first fluid chamber 4A and a side opposite to the direction of action of gravity (direction of arrow G of FIG. 16C)).

The stopper member 19 may be arranged at the side of the first supporting portion CP₁ of the load-transfer member 3A, or may be arranged both at the side of the first supporting portion CP₁ and at the attachment side of the vehicle-body supporting apparatus 1sc to the vehicle body 100B and inside the first fluid chamber 4A. In brief, the stopper member 19 can be arranged inside the case 71 of the vehicle-body supporting apparatus 1sc and between the first supporting portion CP₁ of the load-transfer member 3A and the vehicle body 100B. The stopper member 19 is made of an elastic body and generates a repulsive force when compressed in a direction of action of the load-transfer member 3A (in other words, a direction of action of the vehicle-body supporting apparatus 1sc). The stopper member 19 may be configured with, for example, elastic material such as rubber and resin, a helical spring, disc spring, and air spring.

Even when the air inside the first fluid chamber 4A comes out and the vehicle-body supporting apparatus 1sc becomes incapable of supporting the sprung mass of the vehicle 100 with the air pressure in the vehicle-body supporting apparatus 1sc, the vehicle-body supporting apparatus 1sc can still support the sprung mass by the stopper member 19. Therefore, even when the air leaks out from the first fluid chamber 4A or the like, the stopper member 19 directly contacts with the first supporting portion CP₁ of the load-transfer member 3A so as to support the mass of the vehicle body 100B, whereby the vehicle body 100B can keep running at least at a low speed. As a result, even when the air leakage occurs in the fluid chamber, the vehicle can keep running slowly until arriving at the repair shop or the like. Thus, it is preferable to arrange the stopper member 19 for the enhancement of reliability of the vehicle 100 provided with the vehicle-body supporting apparatus 1sc.

FIG. 16D is a schematic diagram of a structure of another buffer apparatus which is applicable to the suspension system according to the second embodiment. A vehicle-body supporting apparatus 1sd has a similar structure as that of the vehicle-body supporting apparatus 1sc, however, in the vehicle-body supporting apparatus 1sd, a load-transfer member 3B, which is a vibration input unit, penetrates through the first fluid chamber 4A and the second fluid chamber 4B arranged opposite to each other. The first supporting portion CP₁ of the load-transfer member 3B is brought into contact with the first fluid chamber 4A at an opposite side from an opposing surface OP. Further, the second supporting portion CP₂ of the load-transfer member 3B is brought into contact with the second fluid chamber 4B at an opposite side from the opposing surface OP. The load supporting area S1, which is an area of a portion of the first supporting portion CP₁ in contact with the first fluid chamber 4A is larger than the load supporting area S2, which is an area of a portion of the second supporting portion CP₂ in contact with the second fluid chamber 4B. When the load is applied to the vehicle-body supporting apparatus 1sd, the first fluid chamber 4A and the second fluid chamber 4B undergo opposite volumetric changes. Similarly to the vehicle-body supporting apparatuses 1S, 1sc, and the like described above, the vehicle-body supporting apparatus 1sd can damp the transmission of the vibrations of notch frequency to the vehicle body 100B by opening/closing the fluid-path opening/closing unit 8 at the notch frequency.

FIG. 16E is a schematic diagram of a structure of a vehicle-body supporting apparatus which is applicable to a suspension system of the second embodiment. In a vehicle-body supporting apparatus 1se, one end (upper end) of an apparatus casing 2e is connected to the vehicle body 100B, and a bracket member 5e which extends in an opposite direction from the vehicle body 100B (i.e., extends downward) is connected to the lower arm 21L of the suspension system. In the vehicle-body supporting apparatus 1se, the first fluid chamber 4A and the second fluid chamber 4B are divided by flexible members 9A and 9B, respectively so as to form a rolling-lobe air spring. The vehicle-body supporting apparatus 1se employs a cover (second-fluid-chamber cover) 3e of the second fluid chamber 4A as a vibration input unit. The cover 3e is connected to the bracket member 5e. More specifically, the relative vibrations between the lower arm 21L and the vehicle body 100B are transmitted to the cover 3e of the second fluid chamber 4B via the bracket member 5e. The second-fluid-chamber cover 3e of the vehicle-body supporting apparatus 1se has the function as the vibration input unit for the fluid chamber of the vehicle-body supporting apparatus, which is similar to the function of the piston 3 of the vehicle-body supporting apparatus 1S of FIG. 15A and the load-transfer member 3A of the vehicle-body supporting apparatus 1sc of FIG. 16C.

The vehicle-body supporting apparatus 1sc of FIG. 16C includes the first fluid chamber 4A and the second fluid chamber 4B arranged at positions facing the load-transfer member 3A, respectively, so as to stabilize the suspension system with the mutually pushing force of the first fluid chamber 4A and the second fluid chamber 4B. On the other hand, the vehicle-body supporting apparatus 1se of FIG. 16E obtains the similar effect as that of the vehicle-body supporting apparatus 1sc of FIG. 16C by making the first fluid chamber 4A and the second fluid chamber 4B push the second-fluid-chamber cover 3e which is made integral with the bracket member 5e connected to the lower arm 21L of the suspension system. In the vehicle-body supporting apparatus 1se, the bracket member 5e and the second-fluid-chamber cover 3e serve as a vibration input unit. When the use efficiency of space is considered, the vehicle-body supporting apparatus 1se of FIG. 16E is more advantageous than the vehicle-body supporting apparatus 1sc of FIG. 16C. Further, the vehicle-body supporting apparatus 1se of FIG. 16E is appropriate for a so-called strut-type suspension system.

In the vehicle-body supporting apparatus 1se, the first fluid chamber 4A and the second fluid chamber 4B are connected via the fluid passage 7. The fluid-path opening/closing unit 8 is provided in the fluid passage 7. The vehicle-body supporting apparatus 1se damps the transmission of vibrational components having the same frequency as the notch frequency by opening/closing the fluid-path opening/closing unit 8 at the notch frequency which is set corresponding to the characteristics of vibration detected by a vibration detector (for example, the vehicle-body acceleration sensor 30 and the suspension-system acceleration sensor 31; see FIG. 15A). Thus, the vehicle-body supporting apparatus 1se is advantageous in that the effect of vibration transmission damping is hardly deteriorated since the vehicle-body supporting apparatus 1se follows the characteristics of vibration that change over time.

FIG. 16F is a schematic diagram of a structure of a vehicle-body supporting apparatus which is applicable to the suspension system according to the second embodiment. A vehicle-body supporting apparatus 1sf is similar to the vehicle-body supporting apparatus 1se of FIG. 16E, except that an inner wall surface of the first fluid chamber 4A is formed with an inner wall surface of an outer cylinder 2A, and that an inner wall surface of the second fluid chamber 4B is formed with an inner wall surface of an inner cylinder 3f. In a bottom portion 10 of the outer cylinder 2A, a through hole 73 is formed. The inner cylinder 3f runs through the through hole 73.

Further, a flexible member 9A forming the first fluid chamber 4A is arranged between the outer cylinder 2A and the inner cylinder 3f, and a flexible member 9B forming the second fluid chamber 4B is arranged between the inner cylinder 3f and the bottom portion 10 of the outer cylinder 2A. In the vehicle-body supporting apparatus 1sf, the inner cylinder 3f and a bracket 5f connected to the inner cylinder 3f form a vibration input unit.

The vehicle-body supporting apparatus 1sf includes a first stopper member 19a arranged at the attachment side of the vehicle body of the outer cylinder 2A, and a second stopper member 19b arranged at the bottom portion 10 of the outer cylinder 2A. At the center of the first stopper member 19a and the second stopper member 19b, the fluid passage 7 is formed to connect the first fluid chamber 4A and the second fluid chamber 4B. The fluid-path opening/closing unit 8 is provided in the fluid passage 7. The vehicle-body supporting apparatus 1sf damps the transmission of vibrational components having the same frequency as the notch frequency by opening/closing the fluid-path opening/closing unit 8 at the notch frequency which is set corresponding to the characteristics of vibration detected by a vibration detector (for example, the vehicle-body acceleration sensor 30 and the suspension-system acceleration sensor 31; see FIG. 15A). Thus, the vehicle-body supporting apparatus 1sf is advantageous in that the effect of vibration transmission damping is hardly deteriorated since the vehicle-body supporting apparatus 1sf follows the characteristics of vibration that change over time. The principle of the present invention is similarly applicable to air springs which have dynamically opposing relation and form a pair, even when the first fluid chamber 4A and the second fluid chamber 4B are not geometrically opposed to each other.

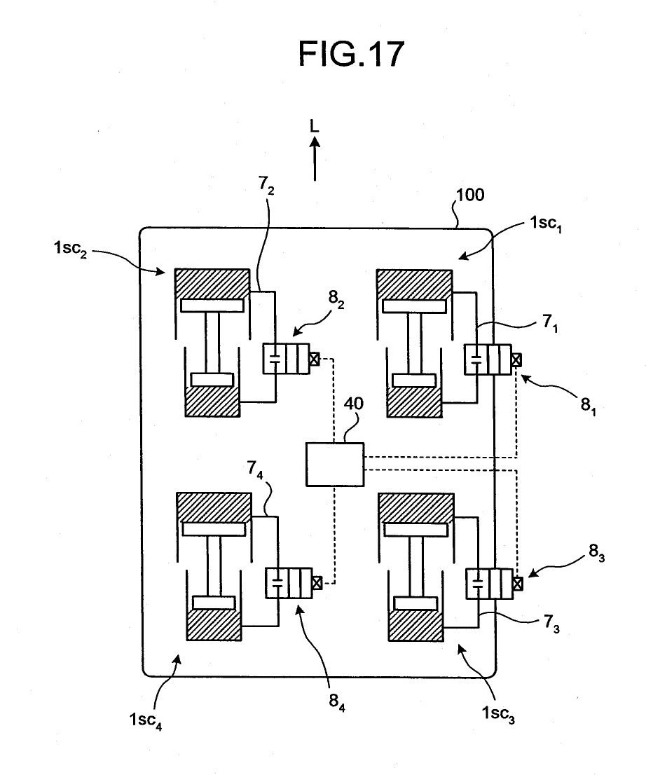

FIG. 17 is a conceptual diagram of the vehicle-body supporting apparatus of the second embodiment arranged to a vehicle. FIG. 17 shows the vehicle-body supporting apparatus 1sc shown in FIG. 16C arranged to each of four wheels of the vehicle 100. An advancing direction of the vehicle 100 is shown by an arrow L of FIG. 17. Vehicle-body supporting apparatuses 1sc₁, 1sc₂, 1sc₃, 1sc₄ are arranged at positions of a right-side front wheel, a left-side front wheel, a right-side rear wheel, and a left-side rear wheel, respectively in the vehicle 100. The vehicle-body supporting apparatuses 1sc₁, 1sc₂, 1sc₃, 1sc₄ damp the transmission of vibrations of a specific frequency by opening/closing fluid-path opening/closing units 8₁, 8₂, 8₃, 8₄ provided in fluid passages 7₁, 7₂, 7₃, 7₄, respectively, at a specific frequency using the vibration controller 40, as described above. The vibration controller 40 of the vehicle-body supporting apparatus 1S of the second embodiment will be described.

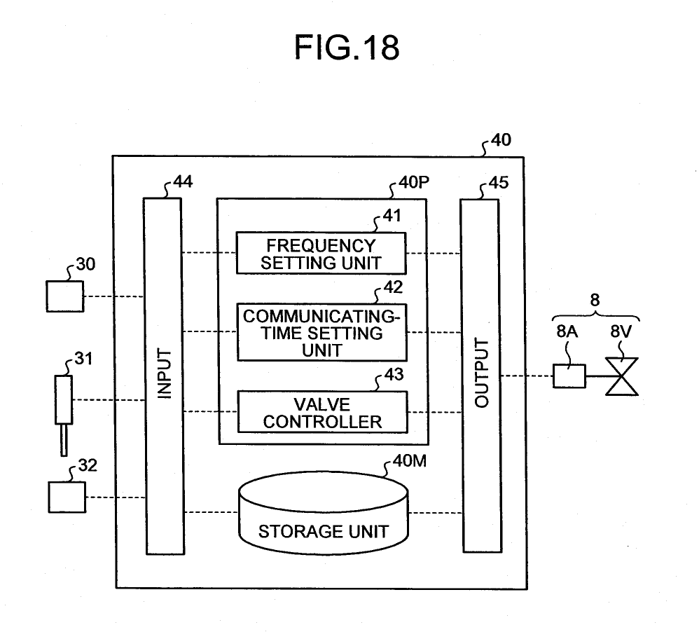

FIG. 18 is a schematic diagram of a structure of the vibration controller according to the second embodiment.

The vibration controller 40 includes a CPU (Central Processing Unit) 40P, a storage unit 40M, an input port 44, and an output port 45.

The CPU 40P of the vibration controller 40 includes a frequency setting unit 41, a communicating-time setting unit 42, and a valve controller (fluid-path opening/closing unit controller) 43. These are the components performing the vibration control of the embodiment. The frequency setting unit 41, the communicating-time setting unit 42, and the valve controller 43 of the vibration controller 40 are connected with each other via the input port 44 and the output port 45. Thus, the frequency setting unit 41, the communicating-time setting unit 42, and the valve controller 43 of the vibration controller 40 are configured so as to be able to send control data with each other and to send command unilaterally.

Further, the CPU 40P and the storage unit 40M are connected via the input port 44 and the output port 45. Thus, the vibration controller 40 can store data in the storage unit 40M, and utilize data, computer programs, and the like stored in the storage unit 40M.

Sensors such as the vehicle-body acceleration sensor 30 and the stroke sensor 32 which serve for acquiring information necessary for the control of the vehicle-body supporting apparatus 1S are connected to the input port 44. Thus, the CPU 40P can acquire necessary information for the control of the vehicle-body supporting apparatus 1S. The actuator 8A which controls opening/closing operations of the on-off valve 8V, which forms the fluid-path opening/closing unit 8 and is a control target necessary for the vibration control, is connected to the output port 45. With the above-described structure, the CPU 40P can open/close the on-off valve 8V forming the fluid-path opening/closing unit 8 at a specific frequency based on output signals provided from the sensors.

The storage unit 40M stores data, computer programs, and the like which includes instructions on procedures of vibration control according to the embodiment. The storage unit 40M may be configured with a volatile memory such as a RAM (Random Access Memory), a non-volatile memory such as a flash memory (registered trademark), or a combination thereof.

The computer program described above may allow the execution of the instruction on the procedure of the vibration control of the embodiment in combination with a computer program previously stored. Further, the vibration controller 40 may realize the functions of the frequency setting unit 41, the communicating-time setting unit 42, and the valve controller 43 using a dedicated hardware in place of the computer program. The control of the vehicle-body supporting apparatus 1S of the second embodiment will be described.

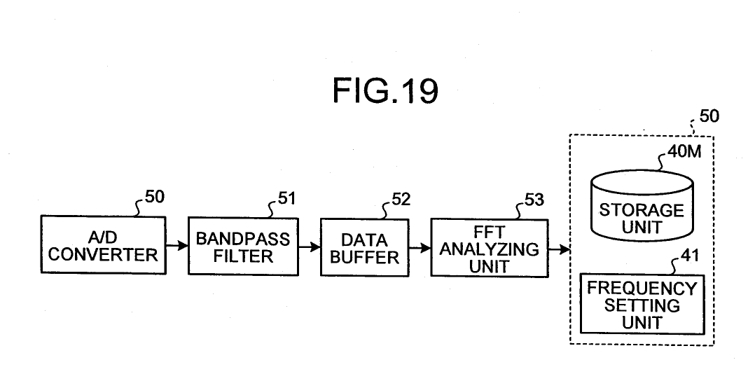

FIG. 19 is a functional block diagram of components performing Fourier analysis according to the second embodiment. In the following, as an example of the control of the vehicle-body supporting apparatus 1S of the second embodiment, transmission damping of vibrational components of the prominent frequency among the vibrational components of the vehicle body 100B will be described. Firstly, the frequency setting unit 41 sets the frequency (notch frequency) of vibration whose transmission to the vehicle body 100B is to be blocked. In the second embodiment, the frequency setting unit 41 acquires the vibrational components of the vehicle body 100B based on the acceleration of the vehicle body 100B (above the spring) acquired from the vehicle-body acceleration sensor 30. The vibrations of the vehicle body 100B as acquired can be represented by a graph as shown in FIG. 6, for example.

The damping of transmission of vibrations which have significant influence on the passenger of the vehicle is effective for damping the vibration transmitted from the road surface to the vehicle body 100B via the vehicle-body supporting apparatus 1S and to provide a comfortable ride for the passenger of the vehicle 100. One manner of determining the level of influence to the passenger is to base the determination on a level of power spectrum. This manner of determination is based on an assumption that the vibrational component of high power dominates the vibrations as a whole and that the vibrational component of low power is not dominant in the vibrations as a whole. When the vibration whose transmission is to be damped is known (for example, is a natural frequency of a system including the portion of the vehicle 100 above the spring and the vehicle-body supporting apparatus 1S), it is not necessary to determine the vibration whose transmission to the vehicle body 100B is to be damped. The “power” of the vibration means intensity (power) of each frequency when the input vibration is resolved into each frequency component. The power of vibration can be found as a sum of square of sinusoidal coefficient and square of cosine coefficient in the Fourier expansion.

To extract spectrum of high power, i.e., vibrational component which substantially dominates the vibration, from the time-changing vibrations, it is preferable to perform vibration analysis on real time. Here, “vibration analysis on real time” does not mean simultaneity in a narrow sense, but means that a series of operations of acquiring vibrations, sampling data of plural vibrations (e.g., amplitude, power, or energy) from the acquired vibrations at a predetermined time width, performing Fourier analysis, and extracting vibrational components of high-power spectrum is finished within a predetermined time and repeated.

As shown in FIG. 19, vibration signals from the vehicle-body acceleration sensor 30 (see FIG. 15A) are converted from an analog form to a digital form by an A/D (Analog-to-Digital) converter 50. The converted digital vibration signals are taken into a bandpass filter 51 and only the vibrational components of a predetermined frequency band pass through the bandpass filter 51.

When the transmission of vibrations, which makes the passenger of the vehicle 100 feel uncomfortable, to the vehicle body 100B is to be damped, a frequency band of vibrations of interest such as the frequency which the passenger feels uncomfortable, a sprung resonance frequency, an unsprung resonance frequency, and the like are already known. Therefore, the preparation is made to identify the frequency of vibration whose transmission to the vehicle body 100B is to be damped with the use of the bandpass filter 51 which passes the components of the known frequency band.

The vibrations of the frequency band passes through the bandpass filter 51 are temporarily stored in a data buffer 52. When the frequency setting unit 41 of the vibration controller 40 supplies trigger signals indicating the end of analysis of previous data to the data buffer 52, the vibrations of the above-mentioned frequency band stored in the data buffer 52 are sent to an FFT (Fast Fourier Transform) analyzing unit 53 for Fourier analysis. FIG. 7 shows an example of the result of Fourier analysis of vibrations of the vehicle body 100B of FIG. 6.

The FFT analyzing unit 53 converts the vibration of the specific frequency band from a time region into a frequency region. The converted vibration is stored in the storage unit 40M of the vibration controller 40. The frequency setting unit 41 determines the frequency of vibration whose transmission is to be damped based on the result of Fourier analysis stored in the storage unit 40M, in other words, based on the power spectrum. In the second embodiment, the frequency of vibration whose transmission is to be damped is a frequency whose vibrational power (or amplitude, or energy) exceeds a predetermined threshold “as”, and is frequency f₁ in the example shown in FIG. 7.

After the frequency setting unit 41 identifies the frequency for the transmission damping, the vibration controller 40 executes processing for damping the transmission of vibration of the identified frequency to the vehicle body 100B as described later. After the execution of the processing, the frequency setting unit 41 sends a command to the FFT analyzing unit 53 for executing Fourier analysis by acquiring the next data from the data buffer 52. In the second embodiment, the above processing is executed repeatedly to detect the frequency of vibration which has a significant influence on the passenger and to control the vehicle-body supporting apparatus 1S and the like to damp the transmission of vibration of the detected frequency.

After identifying the frequency of vibration whose transmission is to be damped, the frequency setting unit 41 sets the frequency of vibration whose transmission is to be damped or an integral multiple thereof as the opening/closing frequency f₀ of the fluid-path opening/closing unit 8. FIG. 8 shows an example of the valve-opening command pulse. As shown in FIG. 8, the valve-opening command pulse has the pulse period of ta. When the valve is to be opened/closed at the identified frequency for transmission damping, the expression fo=f₁=(1/ta) is satisfied. Further, the communicating-time setting unit 42 sets the pulse width tb of the valve-opening command pulse based on the sustained load of the vehicle-body supporting apparatus 1S (see FIG. 8). The pulse width tb of the valve-opening command pulse indicates the time the on-off valve 8V remains open, i.e., the communicating time of the fluid passage 7 (hereinafter referred to as valve-opening time). It is preferable that the valve-opening time tb be changed according to the level of the vibrational power of the vibration having the frequency whose transmission is to be damped. For example, the valve-opening time tb is made longer as the vibrational power of the vibration having the frequency for transmission damping increases. Then, the gain at the frequency for transmission damping can be made close to zero, whereby the transmission of notch frequency can be damped more securely. Alternatively, the valve-opening time tb may be shortened as the sustained load of the vehicle-body supporting apparatus 1S increases, for example.

The valve controller 43 supplies the valve-opening command pulse to the actuator 8A of the fluid-path opening/closing unit 8 at the opening/closing frequency f₀ set by the frequency setting unit 41 with the pulse width set to the valve-opening time tb set by the communicating-time setting unit 42. Then, as shown in FIG. 9, the vehicle-body supporting apparatus 1S works as a frequency filter having a gain of zero at the frequency f₁ whose transmission is to be damped, and having a gain of approximately 1.0 for frequencies other than the frequency f₁. Thus, the vibration of frequency f₁ whose transmission is to be damped is blocked by the vehicle-body supporting apparatus 1S and would not be transmitted to the vehicle body 100B substantially. Thus, the vibration having the frequency f₁ transmitted to the vehicle body 100B can be damped. When the frequency f₁ for transmission damping is set to the resonance frequency of the vehicle body 100B supported by the vehicle-body supporting apparatus 1S, the resonance amplification can be avoided.

FIGS. 10 to 13 are graphs illustrating other examples of control procedure by the vehicle-body supporting apparatus of the second embodiment. In the following, as an example of the control procedure of the vehicle-body supporting apparatus 1S of the second embodiment, transmission damping of vibrational components of the plural prominent frequency (two frequencies in this example) among the vibrational components of the vehicle body 100B will be described. In this case, the frequency setting unit 41 sets the frequency (frequency for transmission damping) of vibration whose transmission to the vehicle body 100B is to be blocked. The frequency setting unit 41 utilizes the storage unit 40M in which the result of Fourier analysis of the vibrational components of the vehicle body 100B are stored. Result of Fourier analysis is shown in FIG. 10. In the second embodiment, the frequency of vibration whose transmission is to be damped is a frequency whose vibrational power (or amplitude, or energy) exceeds a predetermined threshold “as”, and is frequencies f₁ and f₂ in the example shown in FIG. 10.

After identifying the frequency for the transmission damping, the frequency setting unit 41 sets the valve-opening command pulse for the fluid-path opening/closing unit 8. An example of the valve-opening command pulse is shown in FIGS. 11A and 11B. FIG. 11A shows a valve-opening command pulse for the frequency f₁ for transmission damping, whereas FIG. 11B shows a valve-opening command pulse for the frequency f₂ for transmission damping. As shown in FIG. 11A, the period of the valve-opening command pulse corresponding to the frequency f₁ for transmission damping is t₁ and the expression f₁=(1/t₁) is satisfied. Further, as shown in FIG. 11B, the period of the valve-opening command pulse corresponding to the frequency f₂ for transmission damping is t₂, and the expression f₂=(1/t₂) is satisfied.

When there are plural frequencies whose transmission is to be damped, and vibrational components of these plural frequencies are to be handled, the frequency setting unit 41 employs a combination of the valve-opening command pulse for the notch frequency f₁ and the valve-opening command pulse for frequency f2 as the valve-opening command pulse sequence as shown in FIG. 12. Here, a solid line in FIG. 12 indicates the valve-opening command pulse for the frequency f₁ for transmission damping, and a dashed line indicates the valve-opening command pulse for the frequency f₂ for transmission damping.

The valve controller 43 supplies the valve-opening command pulse sequence set by the frequency setting unit 41 to the actuator 8A of the fluid-path opening/closing unit 8 with the pulse width set to the valve-opening time tb set by the communicating-time setting unit 42 (see FIG. 8). Then, as shown in FIG. 13, the vehicle-body supporting apparatus 1S works as a frequency filter having a gain of zero at the notch frequencies f₁ and f₂ whose transmission is to be damped, and having a gain of approximately 1.0 for frequencies other than the frequencies f₁ and f₂. In other words, the vibrations of the notch frequencies f₁ and f₂ are blocked by the vehicle-body supporting apparatus 1S and would not be transmitted to the vehicle body 100B substantially. Thus, the transmission of vibrations having the frequencies f₁ and f₂ to the vehicle body 100B can be damped.

When one of the plural notch frequencies is set to the resonance frequency of the vibration system of the vehicle 100, the resonance amplification can be avoided. In the buffer apparatus configured with a spring and an oleo damper, the vibration blocking characteristic deteriorates in a high frequency region. The vehicle-body supporting apparatus 1S of the second embodiment can block plural types of vibrations simultaneously by setting the plural notch frequencies. Therefore, the transmission of vibrations to the vehicle body 100B can be damped in a wider frequency range.

In the above, the damping of sprung vibrations of the vehicle 100 by the vehicle-body supporting apparatus 1S and the like is described by way of example. The vehicle-body supporting apparatus 1S and the like of the second embodiment, however, are similarly applicable to the damping of the unsprung vibration of the vehicle 100. In this case, the suspension-system acceleration sensor 31 detects the unsprung vibration of the vehicle 100 instead of the vehicle-body acceleration sensor 30 which detects the vibration of the vehicle body 100B (i.e., sprung vibration of the vehicle 100). The fluid-path opening/closing unit 8 is made to open/close at the notch frequency determined based on the unsprung vibrations detected. Thus, the transmission of the unsprung vibration of the frequency which affects the comfort of the passenger to the vehicle body 100B can be damped, whereby the ride quality of the vehicle 100 can be enhanced. Further, when the unsprung frequency which deteriorates the followability of the wheel 24 with respect to the road surface GL is set as the notch frequency, the deterioration of followability of the wheel with respect to the road surface can be suppressed.

Further, in the above example, the frequency of the vibration whose transmission is to be damped is determined based on the sprung vibration or the unsprung vibration of the vehicle 100 as detected by the vibration detector. Alternatively, however, the frequency of the vibration whose transmission is to be damped may be fixed. For example, the frequency of the vibration whose transmission is to be damped may be set to the natural frequency of the vibration system of the vehicle 100, and the fluid-path opening/closing unit 8 may be opened/closed constantly at a frequency corresponding to the natural frequency. Then, the fluid-path opening/closing unit 8 can be easily controlled. Further, as the natural frequency changes according to the changes in passenger and load, the frequency of the vibration whose transmission is to be damped may be changed according to the result of detection of changes in the natural frequency by the vibration detector.

The exemplary application of the vehicle-body supporting apparatus 1S which is the vibration transmission damping apparatus to the suspension system of the vehicle is described as the second embodiment. The application of the vehicle-body supporting apparatus 1S of the second embodiment, however, is not limited thereto. The vehicle-body supporting apparatus 1S of the second embodiment is applicable to any vehicles in which the transmission of vibration of notch frequency needs to be damped. The vehicle-body supporting apparatus 1S of the second embodiment can be applied, for example, to suspension systems of general vehicles such as bicycles, two-wheel vehicles, trucks, buses, suspension systems of general railroad vehicles such as trains and locomotives, buffer systems such as yaw dampers employed for railroad vehicle, steering dampers for two-wheel vehicles, shock absorbers for wheels of airplanes.

As can be seen from the foregoing, the apparatus of the second embodiment includes a fluid chamber filled with gaseous matter such as air and nitrogen, and a vibration input unit which inputs vibration to the fluid chamber by reciprocating relative to the fluid chamber. A fluid passage connected to the fluid chamber is opened/closed at a frequency for transmission damping set corresponding to a frequency of reciprocation of the vibration input unit relative to the fluid chamber. With the above described structure, the vibration of the frequency for transmission damping is blocked by the vehicle-body supporting apparatus, and would not be transmitted to the structural object supported by the vehicle-body supporting apparatus substantially. When the natural frequency of the vibration system including the vehicle-body supporting apparatus and the mass supported thereby change, the frequency for opening/closing the fluid passage connected to the fluid chamber is changed according to the changes in the vibrational characteristics, whereby the effect of vibration transmission damping with respect to the supported mass can be exerted and the static load remains properly supported. Further, when the frequency for transmission damping is set based on the unsprung vibration of the vehicle, the deterioration in followability of the wheel with respect to the road surface GL can be suppressed.

### INDUSTRIAL APPLICABILITY

As can be seen from the foregoing, the vibration transmission damping apparatus according to the present invention is useful for supporting and suspending a structural object, and more particularly, is suitable for damping the transmission of vibration of a specific frequency to the supported structural object, and for damping the vibrational transmission of a specific frequency generated by the structural object.

1. A vibration transmission damping apparatus which is attached to a structural object to support the structural object, the vibration transmission damping apparatus comprising:
a fluid chamber filled with a fluid and arranged between a vibrational source and the structural object; and
a fluid-path opening/closing unit arranged in a fluid path communicating an inside of the fluid chamber with an outside of the fluid chamber to open/close the fluid path at a predetermined frequency corresponding to a specific frequency.

2. The vibration transmission damping apparatus according to claim 1, further comprising
a fluid chamber filled with a fluid, and
a vibration input unit reciprocating relative to the fluid chamber to input vibration from the vibration source to the fluid chamber, wherein
the fluid-path opening/closing unit opens/closes the fluid path at a predetermined frequency corresponding to a frequency of reciprocation of the vibration input unit relative to the fluid chamber.

3. The vibration transmission damping apparatus according to claim 2, wherein
the fluid chamber includes a first fluid chamber and a second fluid chamber,
the vibration input unit is arranged between the first fluid chamber and the second fluid chamber, and
the fluid path is a passage connecting the first fluid chamber and the second fluid chamber.

4. The vibration transmission damping apparatus according to claim 1, wherein
a frequency detector is attached to the structural object to detect vibration of the structural object, and
the fluid-path opening/closing unit opens/closes the fluid path at a predetermined frequency determined based on the vibration of the structural object detected by the frequency detector.

5. The vibration transmission damping apparatus according to claim 1, wherein
the fluid is gaseous matter.

6. The vibration transmission damping apparatus according to claim 1, wherein
the fluid is liquid.

7. The vibration transmission damping apparatus according to claim 1, wherein
the structural object is a vehicle body of a vehicle, the vibration transmission damping apparatus comprising:
a fluid chamber filled with the fluid and arranged between the vehicle body and a wheel of the vehicle to support the vehicle body; and
a vibration input unit reciprocating relative to the fluid chamber to input vibration from at least one of the vehicle body and the wheel to the fluid chamber, wherein
the fluid-path opening/closing unit opens/closes the fluid path at a predetermined frequency corresponding to a frequency of reciprocation of the vibration input unit relative to the fluid chamber.

8. The vibration transmission damping apparatus according to claim 7, further comprising
a fluid amount detector detecting an amount of the fluid filling the fluid chamber, and
a fluid supply unit supplying the fluid to the fluid chamber when the amount of the fluid filling the fluid chamber detected by the fluid amount detector is a predetermined threshold or less.

9. The vibration transmission damping apparatus according to claim 7, wherein
the fluid chamber includes a first fluid chamber and a second fluid chamber,
the vibration input unit is arranged between the first fluid chamber and the second fluid chamber, and
the fluid path connects the first fluid chamber and the second fluid chamber.

10. The vibration transmission damping apparatus according to claim 9, wherein
the second fluid chamber is arranged opposite to the first fluid chamber,
the vibration input unit is supported by the first fluid chamber and the second fluid chamber, and
a load supporting area of the vibration input unit in contact with the first fluid chamber is larger than a load supporting area of the vibration input unit in contact with the second fluid chamber.

11. The vibration transmission damping apparatus according to claim 7, wherein
the vibration detector is attached to the vehicle so as to detect at least one of a sprung vibration and an unsprung vibration of the vehicle, and
the vibration detector is employed to find a frequency of a maximum vibrational power,
the fluid-path opening/closing unit opens/closes at the found frequency, at an integral multiple of the found frequency, or at a frequency equal to the found frequency divided by an integer.

12. The vibration transmission damping apparatus according to claim 11, wherein
a power of the frequency of the maximum vibration power is identified, and a ratio of an opening time to a closing time at the opening/closing of the fluid-path opening/closing unit is changed according to the level of the vibration power.

13. The vibration transmission damping apparatus according to claim 11, wherein
the vibration detector is employed to find plural frequencies in descending order of vibration power, and
the fluid-path opening/closing unit opens/closes at the found frequencies, or integral multiples of the found frequencies, or frequencies equal to the found frequencies divided by an integer.

14. The vibration transmission damping apparatus according to claim 13, wherein
a ratio of an opening time to a closing time at the opening/closing of the fluid-path opening/closing unit is changed for each of the found frequencies according to the vibrational power of each of the found frequencies.

15. The vibration transmission damping apparatus according to claim 7, further comprising
an elastic body that supports the vibration input unit.
